(19) United States
(12) Patent Application Publication
(10) Pub. No.: US 2026/0226209 A1
(43) Pub. Date: Aug. 6, 2026

(54) POLYETHYLENES AND RELATED BLENDS, ARTICLES, AND METHODS

(71) Applicant: ExxonMobil Technology and Engineering Company, Spring, TX (US)

(72) Inventors: Haiqing Peng, Sugar Land, TX (US); Robert M. Canright, Huffman, TX (US); Kevin J. Leonard, Friendswood, TX (US); Samuel L. Justice, Baton Rouge, LA (US); Timothy M. Boller, Houston, TX (US); Martin Antensteiner, Houston, TX (US); Joshua Usiskin, Baton Rouge, LA (US)

(73) Assignee: ExxonMobil Technology and Engineering Company, Spring, TX (US)

(21) Appl. No.: 19/460,551

(22) Filed: Jan. 27, 2026

Related U.S. Application Data
(60) Provisional application No. 63/754,279, filed on Feb. 5, 2025.

(51) Int. Cl. C08F 110/02; C08J 5/18

(52) U.S. Cl. CPC C08F 110/02; C08J 5/18; C08J 2323/06

(57) ABSTRACT

The present invention relates generally to polyethylenes comprising: (a) a resin density of about 0.950-0.960 g/cm³ (ASTM D1505); (b) a melt index at 2.16 kg loading and 190° C. of about 0.5-2 g/10 min (ASTM D1238); (c) a high load melt index at 21.6 kg loading and 190° C. of about 15-28 g/10 min (ASTM D1238); (d) a polydispersity index of about 3 or less (gel permeation chromatography); and (e) a crystallization peak width at half height of about 5° C. or less (ASTM D3418). Polyethylene films having a film density greater than 0.944 g/cm³ or molded articles may comprise the polyethylenes. Multi-layered films may comprise one or more layers of the polyethylene films. Methods may comprise combining ethylene with a catalyst system in a slurry loop reactor, the catalyst system comprising: (i) bis(n-propylcyclopentadienyl) zirconium dichloride; (ii) a support material; and (iii) an activator; and obtaining the polyethylenes.

### CROSS-REFERENCE TO RELATED APPLICATIONS

The present application claims priority to U.S. Provisional Application No. 63/754,279 filed Feb. 5, 2025, the disclosure of which is incorporated by reference in its entirety.

### FIELD OF THE DISCLOSURE

The present disclosure relates generally to polyethylenes and related blends, articles, and methods.

### BACKGROUND

High-Density polyethylenes (HDPE) are versatile resins. Their structures and properties may be tailored for many fabrication processes and end use applications. HDPE is widely used in rigid applications such as injection molding or roto-molding. For these kinds of end-use applications, impact strengths, and sometimes low temperature impact strengths, are relevant properties. Impact strengths are measured by ASTM D256 Izod impact or ISO 179 Charpy impact. For rigid parts, HDPE may be used for blow-molded bottles, injection molded crates, extruded gas or water pipes, etc.

HDPE may also be used in flexible packaging, such as grocery bags, compression packaging, and stand-up pouches, where high holding force and stiffness are needed. HDPE may also be used in packaging requiring good moisture barrier properties, e.g., packages for cereal, coffee, tea, pet foods, etc. Moisture barrier properties may be measured by a water vapor transmission rate (WVTR) per ASTM F1249. When other factors remain constant, WVTR typically decreases with higher HDPE crystallinity, which is correlated to increased density. For example, commercial HDPE resins marketed for packaging applications for moisture barrier applications typically have melt index values at 2.16 kg loading (MI2) of from 1 g/10 min to 1.2 g/10 min and densities as high as from 0.960 g/cm³ to 0.969 g/cm³.

Increasing HDPE density is a common approach to improving water moisture barrier properties, such as by preparing multimodal compositions (i.e., having a multimodal molecular weight distribution). The low molecular weight modal in general helps to boost the density as it crystalizes more easily and achieves a higher density. The high molecular weight modal helps to keep the melt index of the multimodal composition at a range that is suitable for blown film applications, such as lower than 2 g/10 mins. When the low and high populations are managed correctly, there can be a net gain in density compared with a unimodal composition with narrower molecular weight distribution. To produce bimodal or tri-modal resins, the common commercial approach is to build extra reactors in series, which requires significant capital investments and increased manufacturing operation complexities.

However, improving HDPE barrier properties by increasing density in general will sacrifice other properties such as film machine direction (MD)/tranverse direction (TD) imbalance, high film haze, low film gloss, and impact strength for rigid applications. There is a need for new HDPE compositions with densities <0.960 g/cm³ which can provide films having superior WVTR with reduced film thickness, maintained or improved haze, and easy film extrudability, and which can provide molded articles having superior impact strength, making the HDPE compositions suitable for both flexible and rigid applications.

### SUMMARY OF THE DISCLOSURE

According to an embodiment consistent with the present disclosure, polyethylenes include: (a) a resin density of about 0.950 grams/cubic centimeter (g/cm³) to about 0.960 g/cm³, as measured in accordance with ASTM D1505; (b) a melt index at 2.16 kg loading and 190° C. of about 0.5 grams/10 minutes (g/10 min) to about 2 g/10 min, as measured in accordance with ASTM D1238; (c) a high load melt index at 21.6 kg loading and 190° C. of about 15 g/10 min to about 28 g/10 min, as measured in accordance with ASTM D1238; (d) a polydispersity index of about 3 or less, as measured by gel permeation chromatography; and (e) a crystallization peak width at half height of about 5° C. or less, as measured in accordance with ASTM D3418.

In another embodiment, polyethylene films include a polyethylene and further include a film density greater than 0.944 grams/cubic centimeter (g/cm³).

In another embodiment, multi-layered films include at least one layer of a polyethylene film.

In another embodiment, molded articles include a polyethylene. In a further embodiment, methods comprise: combining ethylene with a catalyst system in a slurry loop reactor, the catalyst system comprising: (i) bis(n-propylcyclopentadienyl) zirconium dichloride; (ii) a support material; and (iii) an activator; and obtaining a polyethylene. These and other features and attributes of the disclosed polyethylenes, related polyethylene blends, related articles, and related methods of the present disclosure and their advantageous applications and/or uses will be apparent from the detailed description which follows.

### BRIEF DESCRIPTION OF THE DRAWING

To assist those of ordinary skill in the relevant art in making and using the subject matter hereof, reference is made to the appended drawings. The following figures are included to illustrate certain aspects of the disclosure and should not be viewed as exclusive configurations. The subject matter disclosed is capable of considerable modifications, alterations, combinations, and equivalents in form and function, as will occur to those skilled in the art and having the benefit of this disclosure.

The FIGURE illustrates a differential scanning calorimetry thermogram showing the crystallization peak of various control and inventive polyethylenes, as set forth in the Examples.

### DETAILED DESCRIPTION

The present disclosure relates generally to polyethylenes and related blends, articles, and methods.

The present disclosure provides polyethylenes comprising (a) a density of about 0.950 grams/cubic centimeter (g/cm³) to about 0.960 g/cm³, as measured in accordance with ASTM D1505; (b) a melt index at 2.16 kg loading and 190° C. (MI2) of about 0.5 grams/10 minutes (g/10 min) to about 2 g/10 min, as measured in accordance with ASTM D1238; (c) a high load melt index (HLMI) at 21.6 kg loading and 190° C. of about 15 g/10 min to about 28 g/10 min, as measured in accordance with ASTM D1238; (d) a polydispersity index (PDI) of about 3 or less, as measured by gel permeation chromatography (GPC); and (e) a crystallization peak width at half height (PWHH) of about 5° C. or less, as measured by differential scanning calorimetry in accordance with ASTM D3418.

### Polyethylenes

As used herein, the term “polymer” generally refers to a substance or material consisting of macromolecules constituted by “mer units.” A “mer unit” is a repeating subunit derived from one or more species of “monomer.” A “monomer” is a molecule that can react together with other same or different monomers to form a macromolecular chain of mer units (i.e., a polymer). A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically.

As used herein, when a polymer or copolymer is referred to as comprising a monomer (e.g., an olefin, or more specifically, ethylene or an alpha-olefin,) the monomer present in such polymer or copolymer is the polymerized form of the monomer. For example, when a copolymer is said to have a monomer (or comonomer) content (e.g., an olefin content, or more specifically, an ethylene content and/or an alpha-olefin content), it is understood that the mer unit in the copolymer is derived from the monomer (or “comonomer”) in the polymerization reaction. A copolymer may have a monomer (or comonomer) content described by weight percent (wt. %), mole percent (mol %), or the like. For example, a copolymer may have a monomer (or comonomer) content of a given wt. % (e.g., 50 wt. % to 55 wt. %, or 80 to 99.9 wt. %, or the like), such that said derived units are present at said given wt. % (e.g., 50 wt. % to 55 wt. %, or 80 to 99.9 wt. %, or the like), based upon the weight of the copolymer (i.e., the monomer content plus comonomer content).

As used herein, the terms “olefin,” alternatively referred to as “alkene,” and grammatical variants thereof, generally refer to a linear, branched, or cyclic compound of carbon and hydrogen having at least one double bond. Olefins may be described by a “Cn” value. As used herein, and unless otherwise specified, the term “Cn” means hydrocarbon(s) having n carbon atom(s) per molecule, wherein n is a positive integer. For example, ethylene may be alternately referred to as C₂ while olefins other than ethylene may be referred to as C₃ (i.e., propene) or higher olefins. The terms “alpha-olefin” refers to an olefin having a terminal carbon-to-carbon double bond in the structure thereof R¹R²C═CH₂, where R¹ is hydrogen and R² may be any hydrocarbyl group, such as R¹ is hydrogen and R² is an alkyl group. A “linear alpha-olefin” is an alpha-olefin wherein R¹ is hydrogen and R² is a linear alkyl group.

As used herein, the terms “polyolefin,” “olefin polymer,” and grammatical variants thereof, generally refer to a polymer comprising olefin-derived units, including polyolefin homopolymers having only olefin-derived units and polyolefin copolymers having olefin-derived units and one or more other monomeric units. As used herein, the terms “polyethylene,” “ethylene polymer,” and grammatical variants thereof, generally refer to a polymer having at least 50 wt. % ethylene-derived units, such as at least 70 wt. % ethylene-derived units, such as at least 80 wt. % ethylene-derived units, such as at least 90 wt. % ethylene-derived units, or at least 95 wt. % ethylene-derived units, or 100 wt. % ethylene-derived units. Polyethylenes include, but are not limited to, ethylene homopolymers having only ethylene-derived units and polyethylene copolymers having ethylene-derived units and one or more other monomeric units, including an ethylene terpolymer.

Polyethylene copolymers as described herein may, for example, include at least one or more other olefin and/or non-olefin comonomer(s). In particular embodiments, polyethylene copolymers comprise one or more alpha-olefin comonomers, such as, but not limited to, a C₃ to C₁₂ alpha-olefin. In one or more embodiments, an alpha-olefin comonomer includes, but is not limited to, propylene, butene, hexene, octene, decene, and dodecene. In particular embodiments, polyethylene copolymers are prepared from the polymerization of ethylene and butene, in other embodiments ethylene and hexene, and in other embodiments ethylene and octene. Preferably, other olefin(s) and/or co-monomer(s) are present in polyethylene copolymers at less than 5 weight percent (wt. %), such as, but not limited to, less than 2 wt. %, or less than 1 wt. %, or less than 0.5 wt. %.

### Polyethylene Density

Polyethylenes of the present invention may be characterized by their density, which is determined according to ASTM D1505-19 (gradient density) using a density-gradient column on a plaque. The plaque is molded according to ASTM D4703-10a, procedure C, and the plaque is conditioned for at least 40 hours at 23° C. to approach equilibrium crystallinity in accordance with ASTM D618-08. Polyethylenes according to various embodiments may have a density ranging from about a1 to about a2 g/cm³, where a1 and a2 may be, independently, 0.930 g/cm³, 0.931 g/cm³, 0.932 g/cm³, 0.933 g/cm³, 0.934 g/cm³, 0.935 g/cm³, 0.936 g/cm³, 0.937 g/cm³, 0.938 g/cm³, 0.939 g/cm³, 0.940 g/cm³, 0.941 g/cm³, 0.942 g/cm³, 0.943 g/cm³, 0.944 g/cm³, 0.945 g/cm³, 0.946 g/cm³, 0.947 g/cm³, 0.948 g/cm³, 0.949 g/cm³, 0.950 g/cm³, 0.951 g/cm³, 0.952 g/cm³, 0.953 g/cm³, 0.954 g/cm³, 0.955 g/cm³, 0.956 g/cm³, 0.957 g/cm³, 0.958 g/cm³, 0.959 g/cm³, 0.960 g/cm³, 0.961 g/cm³, 0.962 g/cm³, 0.963 g/cm³, 0.964 g/cm³, 0.965 g/cm³, 0.966 g/cm³, 0.967 g/cm³, 0.968 g/cm³, 0.969 g/cm³, 0.970 g/cm³, 0.971 g/cm³, 0.972 g/cm³, 0.973 g/cm³, 0.974 g/cm³, or 0.975 g/cm³, and where a1<a2. For example, the density may range from about 0.938 g/cm³ to 0.965 g/cm³, or about 0.950 g/cm³ to about 0.960 g/cm³. Film density may be measured as received using a density column according to ASTM D1505, except without plaque molding according to ASTM D4703-10a and with the 40 hours conditioning replaced with conditioning according to ASTM D618-08 prior to cutting and placing into the column.

### Molecular Structure and Morphology

Polyethylenes of the present invention may be characterized by their distribution and the moments of molecular weight (Mw, Mn, Mz, Mw/Mn, Mz/Mn, etc.), the monomer/comonomer content (C2, C4, C6 and/or C8, and/or others, etc.) and the branching index (g′). These values may be determined by using a high temperature Gel Permeation Chromatography system (Polymer Char GPC-IR) equipped with a multiple-channel band-filter based infrared detector (IR5), an 18-angle light scattering detector and a viscometer. Three Agilent PLgel 10 μm Mixed-B LS columns may be used to provide polymer separation. Detailed analytical principles and methods for molecular weight determinations are described in Paragraphs [0044]-[0051] of PCT Publication WO2019246069A1, which are herein incorporated by reference (noting that the equation c=///referenced in Paragraph therein for concentration (c) at each point in the chromatogram, should properly read c=βI, where β is mass constant and I is the baseline-subtracted IRS broadband signal intensity). Unless specifically mentioned, all the molecular weight moments used or mentioned in the present disclosure are determined according to the light scattering, otherwise known as the “absolute,” determination method (e.g., as referenced in Paragraph of WO2019246069A1, in which the molecular weight (M) at each point is determined from

$$\frac{{K}_{o} c}{Δ R ( θ )} = \frac{1}{MP ( θ )} + 2 {A}_{2} c ,$$

wherein ΔR(θ) is the measured excess Rayleigh scattering intensity at scattering angle θ, c is the polymer concentration, A2 is the second virial coefficient, P(θ) is the form factor for a monodisperse random coil, and K₀, the optical constant for the system, is

$${K}_{o} = \frac{4 {π}^{2} {{n}^{2} ( dn / dc )}^{2}}{{λ}^{4} {N}_{Λ}} ,$$

wherein N_{A} is Avogadro's number, and (dn/dc) is the refractive index increment for the system; for polyethylene homopolymers, dn/dc=0.1048 ml/mg). Where otherwise specifically mentioned as the “conventional” method, or IR molecular weight, determination is according to the description of Paragraphs [0044]-[0045] of the just-noted publication, noting that for the equation in such Paragraph [0044], a=0.695 and K=0.000579 (1-0.75 Wt) are used, where Wt is the weight fraction for hexane comonomer (i.e., 0 for homopolymer, such that K=0.000579), and further noting that comonomer composition, if any, is determined by the ratio of the IRS detector intensity corresponding to CH₂ and CH₃ channel calibrated with a series of PE and P homo/copolymer standards whose nominal values are predetermined by NMR or FTIR (providing methyls per 1000 total carbons (CH₃/1000 TC)) as noted in Paragraph of the just-noted PCT publication).

In various embodiments, polyethylenes have one or more, two or more, or all of the following molecular weight properties:

Weight-average molecular weight (Mw) (determined by light scattering)—Polyethylenes according to various embodiments may have a Mw ranging from about b1 to about b2 grams/mole (g/mol), where b1 and b2 may be, independently, 80,000 g/mol; 90,000 g/mol; 100,000 g/mol; 110,000 g/mol; 120,000 g/mol; 130,000 g/mol; 140,000 g/mol; 150,000 g/mol; 160,000 g/mol; 170,000 g/mol; 180,000 g/mol; 190,000 g/mol; 200,000 g/mol; 210,000 g/mol; 225,000 g/mol; 250,000; or 300,000 g/mol, and wherein b1<b2. For example, the Mw may range from about 90,000 g/mol to about 300,000 g/mol, or about 130,000 g/mol to about 300,000 g/mol, or about 150,000 g/mol to about 180,000, or about 90,000 g/mol to about 120,000 g/mol.

Number-average molecular weight (Mn) (determined by light scattering)—Polyethylenes according to various embodiments may have a Mn ranging from about c1 to about c2 g/mol, where c1 and c2 may be, independently, 30,000 g/mol; 31,000 g/mol; 32,000 g/mol; 33,000 g/mol; 34,000 g/mol; 35,000 g/mol; 36,000 g/mol; 37,000 g/mol; 38,000 g/mol; 39,000 g/mol; 40,000 g/mol; 41,000 g/mol; 42,000 g/mol; 43,000 g/mol; 44,000 g/mol; 45,000 g/mol; 46,000 g/mol; 47,000 g/mol; 48,000 g/mol; 49,000 g/mol; or 50,000 g/mol, and wherein c1<c2. For example, the Mn may range from about 30,000 g/mol to about 35,000 g/mol, or about 35,000 g/mol to about 40,000 g/mol, or about 40,000 g/mol to about 45,000 g/mol, or about 45,000 g/mol to about 50,000 g/mol.

Z-average molecular weight (Mz) (determined by light scattering)—Polyethylenes according to various embodiments may have a Mz ranging from about d1 to about d2 g/mol, where d1 and d2 may be, independently, 50,000 g/mol; 60,000 g/mol; 70,000 g/mol; 80,000 g/mol; 90,000 g/mol; 100,000 g/mol; 110,000 g/mol; 120,000 g/mol; 130,000 g/mol; 140,000 g/mol; 150,000 g/mol; 160,000 g/mol; 170,000 g/mol; 180,000 g/mol; 190,000 g/mol; 200,000 g/mol; 210,000 g/mol; 220,000 g/mol; 230,000 g/mol; 240,000 g/mol, or 250,000 g/mol, and wherein d1<d2. For example, the Mz may range from about 50,000 g/mol to about 250,000 g/mol, or about 100,000 g/mol to about 230,000 g/mol, or about 150,000 g/mol to about 210,000.

Polydispersity index (PDI) (determined by light scattering) (i.e., Mw/Mn ratio, also referred to herein as molecular weight distribution)—Polyethylenes according to various embodiments may have a PDI ranging from about e1 to about e2, where e1 and e2 may be, independently, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0, and wherein e1<e2. For example, the PDI may range from about 0.1 to about 5.0, or about 0.50 to about 4.0, or about 1.0 to about 3.0.

Mz/Mw ratio (determined by light scattering)—Polyethylenes according to various embodiments may have an Mz/Mw ratio ranging from about f1 to about f2, where f1 and f2 may be, independently, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0, and wherein f1<f2. For example, the PDI may range from about 0.1 to about 5.0, or about 1.0 to about 4.0, or about 2.0 to about 3.0, or about 2.0 to about 5.0, or about 3.0 to about 4.0, or less than about 5.0, or less than about 4.0, or less than about 3.0, or less than about 2.0, or about 1.0 to about 2.0.

Branching index (g′)—Branching index may be obtained using GPC in accordance with the methods described in Paragraphs [0048]-[0051] of PCT Publication W02019/246069A1. Polyethylenes according to various embodiments may have a g′ value ranging from about g1 to about g2, where g1 and g2 may be, independently, 0.6, 0.65, 0.7, 0.75, 0.8, 0.85, 0.9, 0.95, 1.0, and wherein g1<g2. For example, the g′ value may range from about 0.6 to about 1.0, or about 0.65 to about 0.95, or about 0.75 to about 0.90.

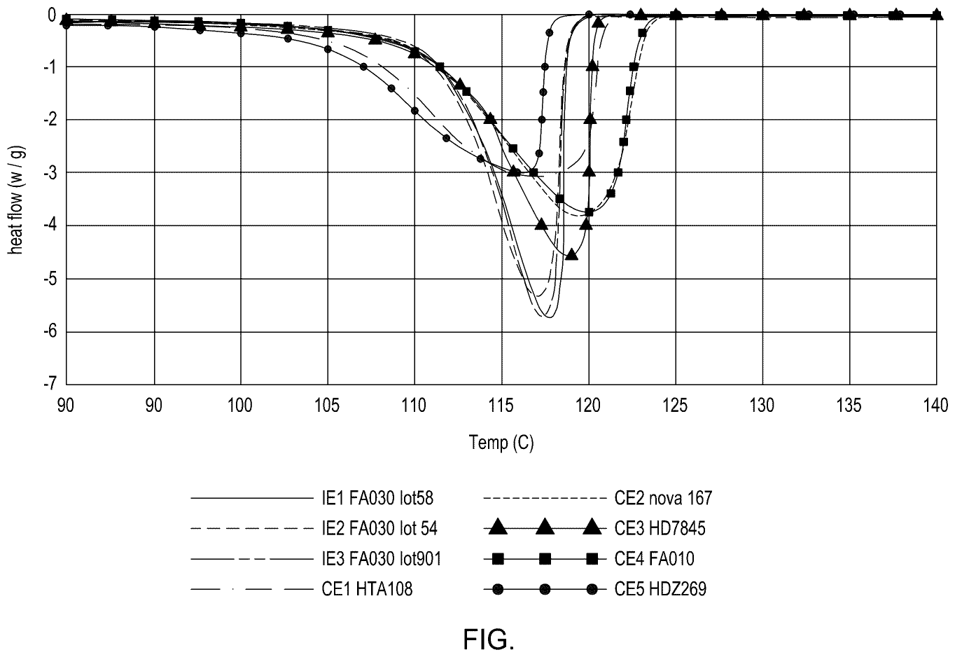

Furthermore, as noted, polyethylenes of various embodiments described herein exhibit unimodal molecular weight distributions, meaning that there is a single distinguishable peak in a molecular weight distribution curve of the composition (as determined using gel permeation chromatography (GPC) or other recognized analytical technique, noting that if there is any conflict between or among analytical techniques, a molecular weight distribution determined by GPC, as described below, shall control). Examples of “unimodal” molecular weight distribution may be seen in U.S. Pat. No. 8,691,715, FIG. 6 of such patent, which is incorporated herein by reference. This is in contrast with a “multimodal” molecular weight distribution, which means that there are at least two distinguishable peaks in a molecular weight distribution curve (again, as determined by GPC or any other recognized analytical technique, with GPC controlling in the event of any conflict). For example, if there are two distinguishable peaks in the molecular weight distribution curve, such composition may be referred to as bimodal composition. For example, FIGS. 1-5 of U.S. Pat. No. 8,691,715 illustrate representative bimodal molecular weight distribution curves. In these figures, there is a valley between the peaks, and the peaks may be separated or deconvoluted. Often, a bimodal molecular weight distribution is characterized as having an identifiable high molecular weight component (or distribution) and an identifiable low molecular weight component (or distribution). Bimodal polyethylene also refers to the compositions made from staged reactors or using mixed catalysts in a single reactor to produce a blend of 2 different compositions, even though the GPC of the blend may appear to have only one peak. Thus, unless indicated otherwise herein, the term “unimodal” when used in connection with polyethylenes, means (1) that the composition is made using a single reaction stage (or multiple parallel reaction stages operating under substantially similar conditions, such that the resulting blend is of two or more like components) and without mixed catalysts; and (2) that the composition exhibits a single peak in GPC analysis.

Polyethylenes of the present invention may be characterized by their level of unsaturation including, but not limited to, the numbers of vinyl groups per 1000 total carbons (vinyl/1000 total carbon), as determined by proton (1H) NMR. Polyethylenes according to various embodiments may have a vinyl/1000 total carbon value of about h1 to about h2, where h1 and h2 may be, independently, 0.10, 0.15, 0.20, 0.25, 0.30, 0.35, 0.40, 0.45, or 0.50, and wherein h1<h2. For example, the vinyl/1000 total carbon may range from about 0.10 to about 0.50, or about 0.10 to about 0.45, or about 0.10 to about 0.40, or about 0.10 to about 0.35, or about 0.10 to about 0.30, or about 0.1 to about 0.25, or about 0.10 to about 0.20, or about 0.10 to about 0.15.

### Thermal Properties and Transitions

Thermal analysis by differential scanning calorimetry (DSC) was performed, conforming to ASTM D3418, in order to generate a thermogram of heat flow (e.g., watts per gram of material (e.g., W/g)) versus temperature (e.g., ° C.). The sample size may be approximately 6 to 8 mg and a detailed DSC sequence may include the following: 1: Sampling interval 0.50 s/pt; 2: Equilibrate at −20.00° C.; 3: Isothermal for 5.00 min; 4: Mark end of cycle 1; 5: Ramp 10.00° C./min to 200.00° C.; 6: Isothermal for 5.00 min; 7: Mark end of cycle 2; 8: Ramp 10.00° C./min to −20.00° C.; 9: Isothermal for 5.00 min; 10: Mark end of cycle 3; 11: Ramp 10.00° C./min to 200.00° C.; 12: Isothermal for 1.00 min; 13: Mark end of cycle 4.

The DSC thermogram may indicate various melting modalities, such as unimodal, bimodal, or polymodal melting peaks each with various peak melting temperatures. The degree of crystallinity may be calculated from the DSC thermogram using the following expression (Hristov and Vasileva 2003), Xc=ΔHf/ΔHf0×100%, where ΔHf is the heat of fusion of the 2nd melt (e.g., J/g) (also referred to herein as melting enthalpy), and ΔHf0 is the heat of fusion of 100% crystalline HDPE, which is taken to be 293 J/g according to Na et al. (Polymer 43 (2002), pages 7367-7376).

The crystallization peak of the DSC thermogram may be used to calculate the peak width at half height (PWHH), for which a narrower value in general reflects a narrower distribution of crystal size of the polymer. PWHH is calculated by multiplying the maximum height of the crystallization peak by 0.5 and measuring the difference between the two temperatures of the crystallization peak at the half height. The heat of crystallization (ΔHc) (i.e., the area of the crystallization peak, also referred to herein as crystallization enthalpy) may be measured, and the absolute value of the crystallization maximum peak height×100 to ΔHc ratio (|MPH×100/ΔHc|) may also be calculated, for which a larger value in general reflects a narrower distribution of crystal size of the polymer. The crystallization peak width in a DSC analysis of HDPE indicates the temperature range over which the majority of the polymer crystallizes during cooling, and a wider peak generally suggests a broader distribution of crystal sizes or a less uniform crystallization process. Gu et al. (Adv. Polym. Techn., 33 (2014), 21384) utilized the crystallization peak width at half height to study distribution of crystallites.

In various embodiments, polyethylenes have one or more, two or more, or all of the following crystallization properties:

Melting Enthalpy (ΔHf)—Polyethylenes according to various embodiments may have a ΔHf value of about i1 to about i2, where i1 and i2 may be, independently, 100 J/g, 105 J/g, 110 J/g, 115 J/g, 120 J/g, 125 J/g, 130 J/g, 135 J/g, 140 J/g, 145 J/g, 150 J/g, 155 J/g, 160 J/g, 165 J/g, 170 J/g, 175 J/g, 180 J/g, 185 J/g, 190 J/g, 195 J/g, 200 J/g, 205 J/g, 210 J/g, 215 J/g, 220 J/g, 225 J/g, 230 J/g, 235 J/g, 240 J/g, 245 J/g, 250 J/g, 255 J/g, 260 J/g, 265 J/g, 270 J/g, 275 J/g, 280 J/g, 285 J/g, 290 J/g, 295 J/g, or 300 J/g, and wherein i1<12. For example, the % ΔHf may range from about 100 J/g to about 300 J/g, such as about 150 J/g to about 275 J/g, or about 175 J/g to about 250 J/g, or about 200 J/g to about 225 J/g, or about 205 J/g, to about 220 J/g.

Crystallization Enthalpy (ΔHc)—Polyethylenes according to various embodiments may have a ΔHc value of about j1 to about j2, where j1 and j2 may be, independently, 100 J/g, 105 J/g, 110 J/g, 115 J/g, 120 J/g, 125 J/g, 130 J/g, 135 J/g, 140 J/g, 145 J/g, 150 J/g, 155 J/g, 160 J/g, 165 J/g, 170 J/g, 175 J/g, 180 J/g, 185 J/g, 190 J/g, 195 J/g, 200 J/g, 205 J/g, 210 J/g, 215 J/g, 220 J/g, 225 J/g, 230 J/g, 235 J/g, 240 J/g, 245 J/g, 250 J/g, 255 J/g, 260 J/g, 265 J/g, 270 J/g, 275 J/g, 280 J/g, 285 J/g, 290 J/g, 295 J/g, or 300 J/g, and wherein j1<j2. For example, the ΔHc may range from about about 100 J/g to about 300 J/g, such as about 150 J/g to about 275 J/g, or about 175 J/g to about 250 J/g, or about 200 J/g to about 225 J/g, or about 205 J/g, to about 220 J/g.

Percent Crystallization, Second Melting Peak, (Xc)—Polyethylenes according to various embodiments may have a percent (%) Xc value of about k1 to about k2, where k1 and k2 may be, independently, 60%, 61%, 62%, 63%, 64%, 65%, 66%, 67%, 68%, 69%, 70%, 71%, 72%, 73%, 74%, 75%, 76%, 77%, 78%, 79%, or 80%, and wherein k1<k2. For example, the % crystallization may range from about 60% to about 80%, such as about 65 to about 80%, or about 65% to about 75%, or about 70 to about 75%.

Crystallization Peak Width at Half Height (PWHH)—Polyethylenes according to various embodiments may have a PWHH value of about 11 to about 12, where 11 and 12 may be, independently, 1° C., 1.5° C., 2° C., 2.5° C., 3° C., 3.5° C., 4° C., 4.5° C., 5° C., 5.5° C., 6° C., 6.5° C., 7° C., 7.5° C., 8° C., 8.5° C., 9° C., 9.5° C., or 10° C., and wherein 11<12. For example, the PWHH may range from about 1° C. to about 10° C., or about 1° C. to about 8° C., or about 1° C. to about 6° C., or about 2° C. to about 9° C., or about 2° C. to about 7° C., or about 2° C. to about 5° C., or about 3° C. to about 8° C., or about 3° C. to about 6° C., or about 4° C. to about 9° C., or about 4° C. to about 7° C., or about 1.5° C. to about 9.5° C., or about 2.5° C. to about 8.5° C., or about 3.5° C. to about 7.5° C. or about 4.5° C. to about 6.5° C., or about 1° C. to about 3° C., or about 2° C. to about 4° C., or about 3° C. to about 5° C., or about 1.5° C. to about 3.5° C., or about 2.5° C. to about 4.5° C., or about 3.5° C. to about 5.5° C., or less than about 10° C., or less than about 8° C., or less than about 6° C., or less than about 5° C., such as from about 3° C. to 5° C.

Absolute Value of Crystallization Maximum Peak Height×100/Heat of Crystallization Ratio (|MPH×100/ΔHc|)—Polyethylenes according to various embodiments may have a |MPH×100/ΔHc| value of about m1 to about m2, where m1 and m2 may be, independently, 1.1 W/J, 1.2 W/J, 1.3 W/J, 1.4 W/J, 1.5 W/J, 1.6 W/J, 1.7 W/J, 1.8 W/J, 1.9 W/J, 2.0 W/J, 2.1 W/J, 2.2 W/J, 2.3 W/J, 2.4 W/J, 2.5 W/J, 2.6 W/J, 2.7 W/J, 2.8 W/J, 2.9 W/J, 3.0 W/J, 3.1 W/J, 3.2 W/J, 3.3 W/J, 3.4 W/J, 3.5 W/J, 3.6 W/J, 3.7 W/J, 3.8 W/J, 3.9 W/J, or 4.0 W/J, and wherein m1<m2. For example, the |MPHx100/ΔHc| may range from about 1 W/J to about 4 W/J, or about 1.5 W/J to about 3.5 W/J, or about 2 W/J to about 3 W/J, or greater than about 1 W/J, or greater than about 1.5 W/J, or greater than about 2 W/J, or greater than about 2.5 W/J, or greater than about 3 W/J.

### Rheological Properties

The polyethylenes of the present invention may be characterized by their melt index (2.16-kilogram (kg) loading) (MI2) values, their high load melt index (HLMI) values (i.e., melt index at 21.6-kg loading), and their melt index ratio (MIR) values, each determined according to ASTM D1238 procedure B, such as by using a Gottfert MI-2 series melt flow indexer. For MI, HLMI, and MIR values reported herein, testing conditions were set at 190° C. and either 2.16 kg (for MI2) and 21.6 kg (for HLMI) load. An amount of 5 g to 6 g of sample is loaded into the barrel of the instrument at 190° C. and manually compressed. Afterwards, the material is automatically compacted into the barrel by lowering all available weights onto the piston to remove all air bubbles. Data acquisition is started after a 6 min pre-melting time. Also, the sample is pressed through a die of 8 mm length and 2.095 mm diameter. MI2 and HLMI values are expressed in terms of the mass of polyethylene which is pressed through the die after 10 min (g/10 min). MIR is defined as HLMI/MI2. MIR and Mw/Mn values provide information about the molecular weight distribution of the polymer chains that make up the polymer composition. However, MIR tends to be more sensitive to features of the polymer chains that impact the composition's rheology; and Mw and Mn as determined by GPC, on the other hand, are not so sensitive to rheological features of the polymer chains.

In various embodiments, the polyethylenes have one or more, two or more, or all of the following rheological properties:

Polyethylenes according to various embodiments may have a MI2 value of about n1 to about n2, where n1 and n2 may be, independently, 0.1 g/10 min, 0.15 g/10 min, 0.2 g/10 min, 0.25 g/10 min, and 0.3 g/10 min, 0.35 g/10 min, 0.4 g/10 min, 0.45 g/10 min, 0.5 g/10 min, 0.55 g/10 min, 0.6 g/10 min, 0.65 g/10 min, 0.7 g/10 min, 0.75 g/10 min, 1 g/10 min, 1.25 g/10 min, 1.5 g/10 min, 1.75 g/10 min, 2 g/10 min, 2.25 g/10 min, 2.5 g/10 min, 3 g/10 min, 4 g/10 min, 5 g/10 min, or 10 g/10 min, and wherein n1<n2. For example, the MI2 may range from about 0.1 g/10 min to about 1 g/10 min, or about 0.25 g/10 min to about 3 g/10 min, or about 0.5 g/10 min to about 5 g/10 min, or about 1 g/10 min to about 7 g/10 min, or about 2 g/10 min to about 9 g/10 min, or about 3 g/10 min to about 10, or about 0.5 g/10 min to about 1.5 g/10 min, or about 0.75 g/10 min to about 1.75 g/10 min, or about 1.0 g/10 min to about 2 g/10 min, or about 1.25 g/10 min to about 2.25 g/10 min.

Polyethylenes according to various embodiments may have a HLMI value of about o1 to about o2, where o1 and o2 may be, independently, 15 g/10 min, 16 g/10 min, 17 g/10 min, 18 g/10 min, 19 g/10 min, 20 g/10 min, 21 g/10 min, 22 g/10 min, 23 g/10 min, 24 g/10 min, 25 g/10 min, 26 g/10 min, 27 g/10 min, 28 g/10 min, 29 g/10 min, 30 g/10 min, 35 g/10 min, 36 g/10 min, 37 g/10 min, 38 g/10 min, 39 g/10 min, 40 g/10 min, 45 g/10 min, 50 g/10 min, 60 g/10 min, 70 g/10 min, or 75 g/10 min and wherein o1<o2. For example, the HLMI may range from about 15 g/10 min to about 35 g/10 min, or about 20 g/10 min to about 30 g/10 min, or about 25 g/min to about 45 g/10 min, or about 15 g/10 min to about 20 g/10 min, or about 20 g/10 min to about 25 g/10 min, or about 25 g/10 min to about 30 g/10 min.

Polyethylenes according to various embodiments may have a MIR value of about p1 to about p2, where p1 and p2 may be, independently, 5, 10, 15, 20, 25, 30, 35, 40, 45, or 50, and wherein p1<p2. For example, the MIR may range from about 5 to about 10, about 10 to about 15, about 15 to about 20, about 20 to about 25, about 25 to about 30, about 30 to about 35, about 35 to about 40, about 40 to about 45, or about 45 to about 50.

Complex viscosity, referred to herein as “Eta” may be determined using SAOS (small amplitude oscillatory shear) testing. SAOS experiments are performed at 190° C. using a 25 mm parallel plate configuration on an ARES-G2B (TA Instruments). Sample test disks (25 mm diameter, 1.5 mm thickness) may be made with a Carver Laboratory press at 190° C. Samples are allowed to sit without pressure for approximately 5 minutes in order to melt and then held under pressure typically for 3 minutes to compression mold the sample. The disk sample is first equilibrated at 190° C. for about 10 minutes between the parallel plates in the rheometer to erase any prior thermal and crystallization history. An angular frequency sweep is next performed with a typical measurement gap of 1.5 mm from 628 rad/s to 0.01 rad/s angular frequency using 5 points/decade and a strain value within the linear viscoelastic region determined from strain sweep experiments, e.g., about 5% strain (see C. W. Macosko, Rheology Principles, Measurements and Applications, Wiley-VCH, New York, 1994). All experiments are performed in a nitrogen atmosphere to minimize any degradation of the sample during the rheological testing.

The complex viscosity |η*(ω)| versus frequency (ω) data obtained for the SAOS experiment is fitted using the Carreau-Yasuda (CY) model to obtain the zero-shear viscosity (i.e., the viscosity in the limit of zero shear rate), alternately referred to herein as “η₀” or “Eta0”. The TA instrument TRIOS software may be used for convenience. The Carreau-Yasuda model below is a parameter that describes the transition between the Newtonian plateau and the power law region, where no is the zero shear rate (alternatively “Eta0”), k is the consistency (characteristic time), n is the power law index, and \dot{γ} is the shear rate, and η_{∞} is the infinite viscosity, which is fixed at 0 for the analysis:

$$\frac{η - {η}_{∞}}{{η}_{o} - {η}_{∞}} = [ 1 + ( k \text{?} .$$

$$\text{?} \text{indicates text missing or illegible when filed}$$

The Carreau-Yasuda model analysis is a built-in method in the TRIOS software that may be conveniently conducted after Cox-Merz transformation which is also a built-in method in the TRIOS software.

Polyethylene viscosity decreases with increasing temperature or decreasing molecular weight. For linear PE over a range of wide MWD, Eta0=(K)(M_{w}^{3.4})exp(E/RT), where the 3.4 power law index was first reported by Fox and Flory in J. Phys. Chem. 1951, 55, 2, 221-234. R is the gas constant, T is the absolute temperature, and E is the flow activation energy. This Eta0 and Mw correlation may be simplified to Eta0=C*Mw^{3.4}, wherein C is the ratio of Eta0 to Mw^{3.4}.

In various embodiments, the polyethylene exhibits shear-thinning rheology, meaning that for increasing shear rates, viscosity decreases. But, advantageously, even at low shear rates (less than 1 rad/s, such as less than 0.5 rad/s, such as at 0.1 and 0.01 rad/s), the complex viscosity of the polyethylenes of such embodiments is relatively low. This rheology suggest good processability for the polyethylenes in extruders or similar equipment.

Accordingly, polyethylenes according to various embodiments may exhibit one or more, such as two or more, or even all, of the following rheological properties:

Eta@628 (i.e., Eta at ω=628 rad/s, 190° C.)—Polyethylenes according to various embodiments may have a Eta@628 value of about q1 to about q2, where q1 and q2 may be, independently, 450 Pa·s, 500 Pa·s, 550 Pa·s, 600 Pa·s, 650 Pa·s, 700 Pa s, 725 Pa·s, 750 Pa·s, 775 Pa·s, 800 Pa·s, 825 Pa·s, 850 Pa·s, 875 Pa·s, 900 Pa·s, 925 Pa·s, 950 Pa·s, 975 Pa·s, or 1000 Pa·s, and wherein q1<q2. For example, Eta@628 may range from about 500 Pa·s to about 600 Pa·s, or about 600 Pa·s to about 700 Pa·s, or 700 Pa·s to about 800 Pa·s, or about 800 Pa·s to about 900 Pa·s.

Phase angle@628 (i.e., Phase angle at ω=628 rad/s, 190° C.)—Polyethylenes according to various embodiments may have a Phase angle@628 value of about r1 to about r2, where r1 and r2 may be, independently, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, and wherein r1<r2. For example, the Phase angle@628 may range from about 20 to about 50, or about 25 to about 45, or about 30 to about 40.

Eta@100 (i.e., Eta at ω=100 rad/s, 190° C.)—Polyethylenes according to various embodiments may have a Eta@100 value of about s1 to about s2, where s1 and s2 may be, independently, 900 Pa·s, 1,000 Pa·s, 1200 Pa·s, 1300 Pa s, 1400 Pa·s, 1500 Pa s, 1600 Pa·s, 1700 Pa·s, 1800 Pa·s, 1900 Pa s, 2000 Pa·s, 2100 Pa s, 2200 Pa s, 2300 Pa·s, 2400 Pa s, 2500 Pa·s, 2600 Pa·s, 2700 Pa·s, 2800 Pa·s, 2900 Pa·s, or 3000 Pa·s, and wherein s1<s2. For example, the Eta@100 may range from about 1000 Pa·s to about 1,500 Pa·s, or about 1500 Pa·s to about 2000 Pa·s, or about 2000 Pa·s to about 3000 Pa·s, or about 1500 Pa·s to about 2000 Pa·s or about 2000 Pa·s to about 2500 Pa·s.

Eta@0.1 (i.e., Eta at ω=0.1 rad/s, 190° C.)—Polyethylenes according to various embodiments may have a Eta@0.1 value of about t1 to about t2, where t1 and t2 may be, independently, 3000 Pa s, 3,500 Pa s, 4000 Pa s, 4500 Pa s, 5000 Pa·s, 5500 Pa·s, 6000 Pa·s, 6500 Pa·s, or 7000 Pa·s, and wherein t1<t2. For example, the Eta@0.1 may range from about 3000 Pa·s to about 4,500 Pa·s, or about 3500 Pa·s to about 5000 Pa·s, or about 4000 Pa·s to about 5500 Pa·s, or about 4500 Pa·s to about 6000 Pa·s or about 5000 Pa·s to about 6500 Pa·s.

Eta@0.01 (i.e., Eta at ω=0.01 rad/s, 190° C.)—Polyethylenes according to various embodiments may have a Eta@0.01 value of about u1 to about u2, where u1 and u2 may be, independently, 3000 Pa·s, 3,500 Pa·s, 4000 Pa s, 4500 Pa s, 5000 Pa s, 5500 Pa s, 6000 Pa·s, 6500 Pa·s, or 7000 Pa·s, and wherein u1<u2. For example, the Eta@0.01 may range from about 3000 Pa·s to about 4,500 Pa·s, or about 3500 Pa·s to about 5000 Pa·s, or about 4000 Pa·s to about 5500 Pa·s, or about 4500 Pa·s to about 6000 Pa·s or about 5000 Pa·s to about 6500 Pa·s.

Strain Ratio (STR) (i.e., a measure of shear-thinning rheological behavior (decreasing viscosity with increasing shear rate), defined as Eta@0.01/Eta@100—Polyethylenes according to various embodiments may have a STR value of about v1 to about v2, where v1 and v2 may be, independently, 1, 1.5, 2, 2.5, 3, 3.5, 4, 4.5, 5, 5.5, 6, 6.5, 7, 7.5, 8, 8.5, 9, 9.5, or 10, and wherein v1<v2. For example, the STR may range from about 1 to about 5, or about 2 to about 6, or about 3 to about 7, or about 4 to about 8, or about 5 to about 9, or about 6 to about 10, or about 1 to about 2, or about 2 to about 3, or about 3 to about 4.

Eta0 (a.k.a. zero-shear viscosity, according to the Carreau-Yasuda model and based on complex viscosity values measured at 190° C. from ω=0.01 rad/s to ω=628 rad/s)—Polyethylenes according to various embodiments may have a Eta0 value of about w1 to about w2, where w1 and w2 may be, independently, 4000 Pa s, 4500 Pa s, 5000 Pa·s, 5500 Pa·s, 6000 Pa·s, 6500 Pa·s, 7000 Pa·s, 7500 Pa·s, 8000 Pa·s, 8500 Pa·s, 9000 Pa s, 9500 Pa·s, or 10,000 Pa·s, and wherein w1<w2. For example, the Eta0 may range from about 4000 Pa·s to about 4500 Pa·s, or about 4500 Pa·s to about 5000 Pa·s, or about 5000 Pa·s to about 5500 Pa·s, or about 5500 Pa·s to about 6000 Pa·s, or about 6000 Pa·s to about 6500 Pa·s, or about 6500 Pa·s to about 7000 Pa·s, or about 4000 Pa·s to about 7000 Pa·s, or about 4000 Pa·s to about 5500 Pa·s, or about 4500 Pa·s to about 6000 Pa·s, or about 5000 Pa·s to about 6500 Pa·s, or about 5500 Pa·s to about 7000 Pa·s.

Eta0/Mw^{3.4} (i.e., ratio of zero-shear viscosity to Mw^{3.4})—Polyethylenes according to various embodiments may have a Eta0/Mw^{3.4} value of about x1 to about x2, where x1 and x2 may be, independently, 1E-14, 2E-14, 3E-14, 4E-14, 5E-14, 6E-14, 7E-14, 8E-14, 9E-14, or 1E-13, and wherein x1<x2. For example, the Eta0/Mw^{3.4} may range from less than about 1E-13, less than about 9E-14, or less than about 8E-14, or less than about 7E-14, or less than about 6E-14, or less than about 5E-14, or less than about 4E-14, or about 4E-14 to about 5E-14.

Storage modulus (G′) and loss modulus (G″) may also be observed by SAOS (small amplitude oscillatory shear) testing. A crossover point, if present, may be observed, where storage modulus (G′) is equal to loss modulus (G″). The crossover point may be described according to the crossover frequency (rad/s), defined as the frequency where Storage modulus (G′) is equivalent to loss modulus (G″) in a frequency scan in the SAOS experiment described above, or the crossover modulus (MPa), defined as the modulus where Storage modulus (G′) is equivalent to loss modulus (G″) in a frequency scan in the SAOS experiment described above. Accordingly, Polyethylenes according to various embodiments may exhibit one or more of the following rheological properties:

Crossover Frequency—Polyethylenes according to various embodiments may have a crossover frequency value of about y1 to about y2, where y1 and y2 may be, independently, 150 rad/s, 175 rad/s, 200 rad/s, 205 rad/s, 210 rad/s, 215 rad/s, 220 rad/s, 225 rad/s, 230 rad/s, 235 rad/s, 240 rad/s, 245 rad/s, 250 rad/s, 255 rad/s, 260 rad/s, 265 rad/s, 270 rad/s, 275 rad/s, 280 rad/s, 285 rad/s, 290 rad/s, 295 rad/s, 300 rad/s, 305 rad/s, 310 rad/s, 315 rad/s, 320 rad/s, 325 rad/s, or 350 rad/s, and wherein y1<y2. For example, the crossover frequency may range from about 150 rad/s to about 350 rad/s, or about 175 rad/s to about 325 rad/s, or about 200 rad/s to about 300 rad/s.

Crossover Modulus—Polyethylenes according to various embodiments may have a crossover modulus value of about z1 to about z2, where z1 and z2 may be, independently, 0.05 megapascal (MPa), 0.1 MPa, 0.11 MPa, 0.12 MPa, 0.13 MPa, 0.14 MPa, 0.15 MPa, 0.16 MPa, 0.17 MPa, 0.18 MPa, 0.19 MPa, 0.2 MPa, 0.21 MPa, 0.22 MPa, 0.23 MPa, 0.24 MPa, 0.25 MPa, 0.26 MPa, 0.27 MPa, 0.28 MPa, 0.29 MPa, 0.3 MPa, 0.35 MPa, 0.4 MPa, 0.5 MPa, or 1 MPa, and wherein z1<z2. For example, the crossover frequency may range from about 0.05 MPa to about 0.4 MPa, or about 0.1 MPa to about 0.35 MPa, or about 0.2 MPa to about 0.3 MPa.

### Methods of Making Polyethylenes

The present disclosure relates to polyethylene polymerization processes where ethylene monomer and optionally one or more comonomers, are contacted with a catalyst. Suitable combinations of ethylene monomer and comonomers are per the discussion above.

Polyethylene polymerization processes (also referred to herein as “polymerization,” “polymerization process”) of the present disclosure may be carried out in any suitable manner. Any suitable suspension, homogeneous, bulk, solution, slurry, or gas phase polymerization process may be used. Such polymerization processes may be run in a batch, semi-batch, or continuous mode. A homogeneous polymerization process is defined to be a process where at least about 90 wt. % of the product is soluble in the reaction medium. A bulk polymerization process is defined to be a polymerization process where monomer concentration in all feeds to the reactor is 70 volume % or more. Alternately, no solvent or diluent is present or added in the reaction medium (except for the small amounts used as the carrier for the catalyst system or other additives, or amounts typically found with the monomer; e.g., propane in propylene). A single polymerization process and/or reactor may be used, or multiple polymerization processes and/or reactors in parallel or series.

In some embodiments, the polymerization processes are gas phase polymerization processes. Generally, in a fluidized gas bed process used for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. Typically, the gas phase reactor may operate in condensing mode where one or more of the diluents/solvents, as described above, act as an inert condensing agent (ICA) in the fluidized bed reactor for the removal of heat to increase production rates and/or modify polymer properties. See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228.

In some embodiments, the polymerization process is a slurry polymerization process, such as a continuous slurry loop polymerization reaction process. A single slurry loop reactor may be used, or multiple reactors in parallel or series (although, to achieve the unimodal molecular weight distribution in accordance with various embodiments, as discussed previously, it may be preferable that either a single reactor is used, or that the same catalyst, feed, and reaction conditions are used in multiple reactors, e.g., in parallel, such that the composition is considered made in a single reactive step). As used herein, the term “slurry polymerization process” means a polymerization process in which a supported catalyst is used and monomers are polymerized on the supported catalyst particles within a liquid medium (comprising, e.g., inert diluent and unreacted polymerizable monomers), such that a two-phase composition including polymer solids and the liquid circulate within the polymerization reactor. Typically, a slurried tank or slurry loop reactor may be used. In some embodiments herein, a slurry loop reactor is used. In such processes the reaction diluent, dissolved monomers, and catalyst are circulated in a loop reactor in which the pressure of the polymerization reaction is relatively high. The produced solid polymer is also circulated in the reactor. A slurry of polymer and the liquid medium may be collected in one or more settling legs of the slurry loop reactor from which the slurry is periodically discharged to a flash chamber wherein the mixture is flashed to a comparatively low pressure. As an alternative to settling legs, in other examples, a single point discharge method may be used to move the slurry to the flash chamber. The flashing results in substantially complete removal of the liquid medium from the polymer, and the vaporized polymerization diluent (e.g., isobutane) is then recompressed in order to condense the recovered diluent to a liquid form suitable for recycling as liquid diluent to the polymerization zone. The cost of compression equipment and the utilities required for its operation often amounts to a significant portion of the expense involved in producing s.

Slurry polymerization processes suitable for achieving such embodiments may be based on those described in, e.g., U.S. Pat. No. 6,204,344, col. 8, line 30 to col. 9, line 48 & FIG. 1, which portions are incorporated by reference herein; the entirety of the '344 patent is incorporated by reference herein in jurisdictions where such incorporation is permitted. More generally, the '344 patent describes an embodiment of a slurry polymerization system that includes a two-stage flash system for diluent recovery and recycling and associated methods for diluent recovery and recycling. The '344 patent discloses, inter alia, an apparatus for continuously recovering polymer solids from a polymerization effluent comprising a slurry of said polymer solids in a liquid medium comprising an inert diluent and unreacted monomers, which apparatus may be employed in embodiments in accordance with the present disclosure (although other slurry polymerization systems and apparatus may just as well be employed in accordance with various other embodiments). The apparatus described in the '344 patent includes a discharge valve on a slurry reactor, examples of which include slurry loop reactors and stirred tank slurry reactors, for the continuous discharge of a portion of the slurry reactor contents into a first flash tank. The first flash tank operates at a pressure and slurry temperature such that a substantial portion of the liquid medium will be vaporized and the inert diluent component of said vapor is condensable, without compression, by heat exchange with a fluid. The first flash tank is in fluid communication with a second flash tank via a pressure seal that allows plug flow of a concentrated slurry into a second flash tank that operates at a temperature of the concentrated polymer solids/slurry and pressure such that any remaining inert diluent and/or unreacted monomer will be vaporized and removed overhead for condensation by compression and heat exchange and the polymer solids are discharged from the bottom of said second flash tank for additional processing or storage. A complete polymer production plant will include a number of these and other components (e.g., components for handling solids, liquids and gases, such as but not limited to separator systems such as cyclones and accumulator drums; pumps; sensors or meters of flow, pressure, and/or temperature; and the like).

The liquid diluent employed in the polymerization medium is typically an alkane having from 3 to 7 carbon atoms. The medium employed should be liquid under the conditions of polymerization and relatively inert. In some embodiments, a branched alkane may be a preferred diluent. In further embodiments, a hexane or an isobutane diluent is employed. More generally, suitable diluents/solvents for polymerization include non-coordinating, inert liquids. Non-limiting examples of diluents/solvents generally include straight and branched-chain hydrocarbons, such as isobutane, butane, pentane, isopentane, hexane, isohexane, heptane, octane, dodecane, and mixtures thereof, cyclic and alicyclic hydrocarbons, such as cyclohexane, cycloheptane, methylcyclohexane, methylcycloheptane, and mixtures thereof, such as may be found commercially (Isopar™ isoparaffin solvents, available from ExxonMobil Chemical at www.exxonmobilchemical.com); perhalogenated hydrocarbons, such as perfluorinated C₄ to C₁₀ alkanes, chlorobenzene, and aromatic and alkylsubstituted aromatic compounds, such as benzene, toluene, mesitylene, and xylene. Suitable solvents also include liquid olefins which may act as monomers or comonomers including, but not limited to, ethylene, propylene, 1-butene, 1-hexene, 1-pentene, 3-methyl-1-pentene, 4-methyl-1-pentene, 1-octene, 1-decene, and mixtures thereof. In some embodiments, aliphatic hydrocarbon solvents are used as the solvent, such as isobutane, butane, pentane, isopentane, hexane, isohexane, heptane, octane, dodecane, or mixtures thereof; cyclic and alicyclic hydrocarbons, such as cyclohexane, cycloheptane, methylcyclohexane, methylcycloheptane, or mixtures thereof.

Slurry polymerization processes may be run at any temperature and/or pressure suitable to obtain the desired polyethylenes. Polyethylenes according to various embodiments may be produced in one or more slurry reactors (e.g., slurry tanks or slurry loops). Polyethylenes according to various embodiments may be polymerized at a slurry reactor temperature value of about B1 to about B2, where B1 and B2 may be, independently, 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., 110° C., and wherein B1<B2. For example, the slurry reactor temperature may range from about 80° C. to 110° C., such as 85° C. to 108° C., 90° C. to 105° C., 92° C. to 102° C., or 95° C. to 100° C. Polyethylenes according to various embodiments may be polymerized at a slurry reactor pressure value of about C1 to about C2, where C1 and C2 may be, independently, 400 psig, 425 psig, 450 psig, 475 psig, 500 psig, 525 psig, 550 psig, 575 psig, 600 psig, 625 psig, 650 psig, 675 psig, 700 psig, 725 psig, 750 psig, 775 psig, or 800 psig, and wherein C1<C2. For example, the slurry reactor pressure may range from about 425 psig to 800 psig, such as from 450 psig to 650 psig; or 500 psig to 600 psig.

Hydrogen may be added to a slurry reactor for molecular weight control of the polyethylenes during polymerization. Hydrogen concentration values may be manipulated within a specified range in response to testing of periodic lab samples (e.g., measuring melt flow rate) to achieve desirable molecular weight distribution of final resins. Slurry polymerization processes may be run in a slurry reactor containing various hydrogen concentration values (i.e., ppm hydrogen versus the ethylene feed ratio). Polyethylenes according to various embodiments may be polymerized at a hydrogen concentration value of about D1 to about D2, where D1 and D2 may be, independently, 0 ppm, 0.1 ppm, 0.2 ppm, 0.3 ppm, 0.4 ppm, 0.5 ppm, 0.6 ppm, 0.7 ppm, 0.8 ppm, 0.9 ppm, 1.0 ppm, 1.5 ppm, 2 ppm, 2.5 ppm, 3 ppm, 3.5 ppm, 4 ppm, 4.5 ppm, or 5 ppm (versus the ethylene feed concentration), and wherein D1<D2. For example, the hydrogen concentration (i.e., ppm hydrogen versus the ethylene feed ratio) may range from about 0 ppm to about 1 ppm, or about 1 ppm to about 2 ppm, or about 2 ppm to about 3 ppm, or about 3 ppm to about 4 ppm, or about 4 ppm to about 5 ppm.

Slurry polymerization processes may be run at various concentrations of ethylene in the slurry reactor. Typical ethylene addition rates may be between about 30,000 pounds per hour (lbs/hr) of ethylene to about 50,000 lbs/hr of ethylene. The concentration of ethylene in the slurry reactor may be controlled by analytical measurement of the unreacted ethylene exiting from the slurry reactor in the effluent stream (i.e., wt. % excess ethylene). Manipulating the wt. % of excess (unreacted) ethylene affects reaction kinetics by varying the amount of ethylene available to polymerize. Polyethylenes according to various embodiments may be polymerized at an wt. % excess ethylene value of about E1 to about E2, where E1 and E2 may be, independently, 1 wt. % excess ethylene, 1.5 wt. % excess ethylene, 2 wt. % excess ethylene, 2.5 wt. % excess ethylene, 3 wt. % excess ethylene, 3.5 wt. % excess ethylene, 4 wt. % excess ethylene, 4.5 wt. % excess ethylene, 5 wt. % excess ethylene, 5.5 wt. % excess ethylene, 6 wt. % excess ethylene, 6.5 wt. % excess ethylene, 7 wt. % excess ethylene, 7.5 wt. % excess ethylene, or 8 wt. % excess ethylene, or 9 wt. % excess ethylene, or 10 wt. % excess ethylene, or 11 wt. % excess ethylene, or 12 wt. % excess ethylene, or 13 wt. % excess ethylene, or 14 wt. % excess ethylene, or 15 wt. % excess ethylene, and wherein E1<E2. For example, the wt. % excess ethylene value may range from about 1 wt. % excess ethylene to about 15 wt. % excess ethylene, or about 1 wt. % excess ethylene to about 12 wt. % excess ethylene, or about 1 wt. % excess ethylene to about 10 wt. % excess ethylene, or about 1 wt. % excess ethylene to about 5 wt. % excess ethylene, or about 3 wt. % excess ethylene to about 7 wt. % excess ethylene, or about 5 wt. % excess ethylene to about 10 wt. % excess ethylene, or about 8 wt. % excess ethylene to about 13 wt. % excess ethylene, or about 10 wt. % excess ethylene to about 15 wt. % excess ethylene.

Slurry polymerization processes may be run in a slurry reactor having various catalyst concentration values (i.e., various frequencies of catalyst addition from a non-continuous catalyst addition system, as measured in rotations per minute (rpm) or the equivalent in pounds of catalyst added to the reactor per hour (lbs catalyst/hr)). Polyethylenes according to various embodiments may be polymerized at a catalyst addition frequency of about G1 to about G2, where G1 and G2 may be, independently, 1 rpm (equivalent to 15 lbs catalyst/hr), 1.5 rpm, 2 rpm, 2.5 rpm, 3 rpm, 3.5 rpm, 4 rpm, 4.5 rpm, 5 rpm, 5.5 rpm, 6 rpm, 6.5 rpm, 7 rpm (equivalent to 30 lbs catalyst/hr), and wherein G1<G2. For example, the catalyst addition frequency may range from about 1 rpm to about 7 rpm (equivalent to about 15 lbs catalyst/hr to about 30 lbs catalyst/hr), or about 1 rpm to about 3 rpm, or about 3 rpm to about 5 rpm, or about 5 rpm to about 7 rpm.

Slurry reactor solids content (i.e., slurry reactor solids wt. %, based on continuous analytical measurement) is an indirect measure of amount of polyethylene inside a slurry reactor system. Slurry reactor solids wt. % may be manipulated to control the rate of reaction. Slurry polymerization processes may be run in a slurry reactor having various slurry reactor solids content values. Polyethylenes according to various embodiments may be polymerized at a slurry reactor solids content of about H1 to about H2, where H1 and H2 may be, independently, 25 wt. %, 26 wt. %, 27 wt. %, 28 wt. %, 29 wt. %, 30 wt. %, 31 wt. %, 32 wt. %, 33 wt. %, 34 wt. %, 35 wt. %, 36 wt. %, 37 wt. %, 38 wt. %, 39 wt. %, 40 wt. %, 41 wt. %, 42 wt. %, 43 wt. %, 44 wt. %, or 45 wt. %, and wherein H1<H2. For example, the reactor solids content may range from about 25 wt. % to about 45 wt. %, or about 30 wt. % to about 40 wt. %, or about 35 wt. % to about 45 wt. %.

### Catalysts for Polymerizing Polyethylenes

As noted, suitable polymerization processes for producing polyethylenes employ a polymerization catalyst. In an embodiment, the polymerization catalyst may include any suitable metallocene catalyst or metallocene catalyst system thereof. Metallocene catalyst systems are known to be capable of polymerizing olefins, such as ethylene and/or alpha-olefins. Metallocene catalyst systems for polymerization of olefins are generally prepared by combining a metallocene catalyst, an activator, and optionally a silica support, which together form the active species for olefin polymerization. In certain embodiments, the metallocene catalyst is a transition metal dihalide metallocene catalyst, M(Cp)₂(X)₂, which includes a transition metal center (M), including, but not limited to Group IV transition metals (e.g., zirconium (Zr)), where M is connected to two optionally substituted cyclopentadienyl moieties (Cp) and two halide leaving groups (X), such as chlorides. The metallocene catalyst may be an unbridged or a bridged metallocene catalyst. As used herein, the terms “bridged” and “unbridged,” and grammatical variants thereof, in reference to a metallocene catalyst, refer to the presence or absence, respectively, of a linking group connecting, i.e., “bridging,” the two cyclopentadienyl (Cp) moieties.

In certain embodiments, the polymerization catalyst may include a metallocene catalyst, such as those metallocene catalysts disclosed in U.S. Pat. No. 6,759,499. Metallocene catalysts may be part of a supported metallocene catalyst system, formed by mixing the metallocene catalyst, and optionally an activator, with an inert carrier, such as silica. The teachings as to metallocene catalysts suitable for polymerization of olefins, systems thereof, and methods of preparation thereof, in the references above are incorporated by reference for purposes of U.S. patent practice. A non-limiting example of a catalyst useful for preparing polyethylenes of the present disclosure is bis(n-propylcyclopentadienyl) zirconium dichloride, the preparation of which is described in detail in U.S. Pat. No. 6,759,499 Comparative Example 3.

### Polyethylene Blends

The present disclosure also provides polyethylene blends of the polyethylenes prior to being formed into a film, fiber, molded article, or other article. The polyethylene blends may optionally include one or more additional polymers. For example, additional polymers may include a polyethylene, an isotactic polypropylene, a highly isotactic polypropylene, a syndiotactic polypropylene, a random copolymer of propylene and ethylene, and/or butene, and/or hexene, polybutene, ethylene vinyl acetate, low density polyethylene (LDPE), linear low density polyethylene (LLDPE), ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, ethylene propylene diene monomer (EPDM) polymer, block copolymer, styrenic block copolymers, polyamides, polycarbonates, polyethylene terephthalate (PET) resins, cross linked polyethylene, copolymers of ethylene vinyl alcohol (EVOH), polymers of aromatic monomers such as polystyrene, poly-1 esters, polyacetal, polyvinylidine fluoride, polyethylene glycols, polyisobutylene, or combination(s) thereof. An additional polymer may be obtained from a post-consumer recycled (PCR) polymer material, and/or, similarly, a post-industrial recycled (PIR) polymer material.

Polyethylene blends according to various embodiments may have polyethylene (of the present disclosure) concentration value of about I1 to about I2, where I1 and I2 may be, independently, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, or 99 wt. %, and wherein I1<I2. For example, the polyethylene (of the present disclosure) concentration in polyethylene blends of the present disclosure may range from about 10 wt. % to about 99 wt. %, or about 20 wt. % to about 95 wt. %, or about 30 wt. % to about 90 wt. %, or about 40 wt. % to about 90 wt. %, or about 50 wt. % to about 90 wt. %, or about 60 wt. % to about 90 wt. %, or about 70 to about 90 wt. %, or about 80 to about 90 wt. %, or about 90 to about 99 wt. %, or about 92 to 98 wt. %. In an embodiment, polyethylene blends according to various embodiments include a PCR polymer, such as a PCR polyethylene, such as a recycled polyethyelene of the present disclosure. In an embodiment, polyethylene blends comprising a PCR polyethylene may have polyethylene (of the present disclosure) concentration of 50 wt. % or more.

The polyethylene blends described above may be produced by mixing the polyethylene of the present disclosure with one or more polymers (as described above) and optional additives, by connecting reactors together in series or in parallel to make reactor polyethylene blends or by using more than one catalyst in the same reactor to produce multiple species of polymer.

Alternatively, the polyethylene blends may be post-reactor polyethylene blends, wherein the polyethylenes and one or more other polymers (and optional additives) may be mixed together prior to being put into an extruder or may be mixed in the extruder. Such polyethylene blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single- or twin-screw extruder, which may include a compounding extruder and a side-arm extruder used directly downstream of a polymerization process, which may include blending powders or pellets of the resins at the hopper of the film extruder.

Additionally, additives may be included in a (reactor or post-reactor) blend, in one or more components of the blend, and/or in a product formed from the blend, such as a film, as desired. Such additives may include, for example: fillers; antioxidants (e.g., hindered phenolics such as IRGANOX® 1010 or IRGANOX® 1076 available from Ciba-Geigy); phosphites (e.g., IRGAFOS® 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; or combination(s) thereof.

### Nucleating Agents

As will be described hereinafter, polyethylenes of the present disclosure may be used as films for food packaging applications. For example, the food packaging industry has a need for improved polyethylenes that may be converted into packaging films that have an improved (reduced) water vapor transmission rate (WVTR). Low WVTR packaging film ensures, for example, that crackers are crispy when opened by the consumer. In addition, low WVTR films may ensure that the packaged food has an acceptable shelf-life.

Blending of nucleating agents with polyethylenes is conventionally effective in reducing the WVTR of barrier films. Nonetheless, the addition of nucleating agents to polyethylenes of the present disclosure is merely optional. The term “nucleating agent” refers to a material that effectively accelerates the phase change from a molten olefin interpolymer product to a solid semi-crystalline olefin interpolymer product. Non-limiting examples of techniques to quantify the efficacy of the nucleating agent include, lower half times of crystallization as measured using a differential scanning calorimeter or measuring the reduction in crystal size as measured using an optical microscope. Nucleating agents may include commercial nucleating agents such as HYPERFORM® HPN-20E or ULTRAGUARD™ 2.0 (available from Milliken & Company, Spartanburg, S.C., USA). According to Milliken U.S. Pat. No. 7,659,336B2 or US20240317971A1, an organic calcium metal salt and/or 500 ppm or 3,000 ppm loading level of active ingredients might be used. Further, nucleating agents may be in masterbatch form (e.g., Milliken's ULTRAGUARD™ 2.0).

Polyethylenes according to various embodiments may have a nucleating agent concentration value of about A1 to about A2, where A1 and A2 may be, independently, 0 parts per million (ppm), 10 ppm, 50 ppm, 100 ppm, 500 ppm, 1000 ppm, 2500 ppm, 5000 ppm, 7,500 ppm, 10,000 ppm, 11,000 ppm, 12,000 ppm, 13,000 ppm, 14,000 ppm, 15,000 ppm, 16,000 ppm, 17,000 ppm, 18,000 ppm, 19,000 ppm, 20,000 ppm, 21,000 ppm, 22,000 ppm, 23,000 ppm, 24,000 ppm, or 25,000 ppm, and wherein Ay1<A2. Alternatively, the nucleating agent may also be added in masterbatch form including, but not limited to, Milliken's ULTRAGUARD™ 2.0, with loading level of 50,000 ppm or less, such as 45,000 ppm or less, or 40,000 ppm or less, or 35,000 ppm or less, or 30,000 ppm or less, or 25,000 ppm or less, or 20,000 ppm or less, or 10,000 ppm or less, or 5,000 ppm or less, or 2,000 ppm or less, or 1,000 ppm or less, or 500 ppm or less, or 250 ppm or less, or 100 ppm or less, or 10 ppm or less, or about 1000 ppm to about 5000 ppm, or about 5000 ppm to about 10,000 ppm, or about 10,000 ppm to about 15,000 ppm, or about 15,000 to about 20,000 ppm, or about 20,000 ppm to about 25,000 ppm, or about 25,000 ppm to about 30,000 ppm, or about 30,000 ppm to about 35,000 ppm, or about 35,000 ppm to about 40,000 ppm, or about 40,000 ppm to about 45,000 ppm, or about 45,000 ppm to about 50,000 ppm.

A nucleating agent may be considered “absent” from the polyethylenes or related films (or equivalently, the composition or film may be “devoid” of nucleating agent) at 0 ppm nucleating agent; and a nucleating agent may be “substantially absent” or the film/composition “substantially devoid” of nucleating agent at 100 ppm or less nucleating agent, preferably 10 ppm or less.

### End Use Applications

Polyethylenes and/or polyethylene blends of the present disclosure may be useful in forming various articles, including but not limited to films (monolayer or multilayer), fibers, molded articles, or other articles. Articles comprising polyethylenes and/or polyethylene blends of the present disclosure may be formed by extrusion, coextrusion, casting, lamination, gas-assisted injection molding, extrusion blow molding, injection blow molding, injection stretch blow molding, compression molding, rotational molding, foam molding, thermoforming, sheet extrusion, profile extrusion, machine direction orientation (MDO), or biaxial orientation, etc.

### Film and Fiber Applications

Films produced by processes described herein may be used in shrink films, cling films, stretch films, sealing films, oriented films, snack packaging, heavy duty bags, grocery sacks, baked and frozen food packaging, medical packaging, industrial liners, membranes, etc., in both food-contact and non-food contact applications. Fibers produced by various processes, including melt spinning, solution spinning and melt blown fiber operations, may be used in woven or non-woven form to make filters, diaper fabrics, medical garments, geotextiles, etc, while extruded articles may be used in medical tubing, wire and cable coatings, geomembranes, and pond liners, among other applications.

Film applications may include, for example, mono- or multi-layer blown, extruded, and/or shrink films. These films may be formed by any number of well-known extrusion or coextrusion techniques, such as a blown bubble film processing technique, wherein the composition may be extruded in a molten state through an annular die and then expanded to form a uniaxial or biaxial orientation melt prior to being cooled to form a tubular, blown film, which may then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxial orientation may be accomplished using typical cold drawing or hot drawing methods. Biaxial orientation may be accomplished using tenter frame equipment or a double bubble process and may occur before or after the individual layers are brought together. For example, polyethylenes layer may be extrusion coated or laminated onto an oriented polypropylene layer, or the polyethylene and the polypropylene may be coextruded together into a film and then oriented. Likewise, oriented polypropylene could be laminated to oriented polyethylene or vice versa, then optionally the combination could be oriented even further. For example, the films may be oriented in the Machine Direction (MD) at a ratio of up to 15, such as from about 5 to about 7, and in the Transverse Direction (TD) at a ratio of up to 15, such as from about 7 to about 9. However, in another embodiment the film is oriented to the same extent in both the MD and TD directions.

In any of the embodiments above, one or more polyethylene and/or polyethylene blend layers of a multilayer film may be replaced with a substrate layer, such as glass, plastic, paper, metal, etc., or the entire film may be coated or laminated onto a substrate. Thus, although the discussion herein has focused on multilayer films, the films may also be used as coatings for substrates such as paper, metal, glass, plastic, and any other suitable material.

In another embodiment, one or more layers may be modified by corona treatment, electron beam irradiation, gamma irradiation, flame treatment, or microwave. In at least one embodiment, one or both of the outer layers is modified by corona treatment.

Films according to various embodiments may have a polyethylene (of the present disclosure) concentration value of about J1 to about J2, where J1 and J2 may be, independently, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, 99 wt. %, or 100 wt. %, and wherein J1<J2. For example, the polyethylene (of the present disclosure) concentration in a film of the present disclosure may range from about 10 wt. % to about 100 wt. %, or about 20 wt. % to about 99 wt. %, or about 30 wt. % to about 95 wt. %, or about 40 wt. % to about 80 wt. %, or about 50 wt. % or more, or about 60 wt. % or more, or about 70 wt. % or more, or about 80 wt. % or more, or about 90 or more wt. %, or about 95 wt. % or more.

In an embodiment, films according to various embodiments may contain a PCR polymer, such as a PCR polyethylene, such as a recycled polyethylene of the present disclosure. In an embodiment, films comprising a PCR polyethylene may have a polyethylene (of the present disclosure) concentration of 50 wt. % or more. In films comprising a polyethylene (of the present disclosure) concentration of less than 100 wt. %, the films may comprise one or more film layers having a polyethylene (of the present disclosure) concentration of 100% and at least one additional film layer comprising one or more other polymers, polyethylene blends of the present disclosure, or any combination thereof.

A monolayer or multilayer film containing the inventive composition may be pre-formed by using a blown film extrusion line. The operation of a blown film line is known to skilled persons in the art. The thickness of the film depends on the final film target thickness and the draw ratio of machine direction orientation (MDO) process. The films should be heated when performing stretching. Stretching may be achieved by different approaches and equipment known to skilled person in the art. One non-limiting example is differential speed rolls.

In some embodiments, biaxially oriented sheets or films may be formed. In one example, sheets or films comprising polyethylenes or polyethylene blends of the present disclosure may be extruded, or melt blended and coextruded, such as through a 3-, 4-, 5-, 7-layer die head, into the desired preformed film. Film extruders are known to skilled persons in the art, where a screw size may be 100 mm to 400 mm, and length to diameter ratios ranging from 10/1 to 50/1 may be used to melt blend the molten layer materials. The polymer melt exits the die having a die gap(s) of 0.5 to 3 or 4 or 5 or 6 mm. The extruded film is then cooled using air, water, or both to form the un-oriented films. The un-oriented film is consequently reheated to a temperature of 100° C. to 120° C. or 150° C., such as a temperature of 118° C. to 135° C., and then passed between differential speed rolls to achieve machine direction orientation stretch followed by transverse orientation stretch. Examples of MD and TD stretching may be found at U.S. Pat. No. 8,080,294B2, incorporated by reference herein. In some embodiments, the film(s) described herein are biaxially oriented with at least 2- to 8-fold TD orientation and at least a 2- or 3- or 8-fold MD orientation.

### Production of Blown Film

Typically, a conventional polyolefin composition for blown film applications has an MI2 of less than 2 (lower MI2=higher MW). The molecular weight of the polyolefin composition should be high enough to form a bubble (otherwise there is not enough stress to form the bubble). In contrast, for cast films, a polyolefin composition having an MI2 of 2 to 4 generally cannot be blown into films (i.e., the polyolefin composition may be extruded).

Blown film extrusion involves the process of extruding a polyethylene (or blend thereof) through a die followed by a bubble-like expansion. Advantages of manufacturing film in this manner include: (1) a single operation to produce tubing; (2) regulation of film width and thickness by control of the volume of air in the bubble; (3) high extruder output and haul-off speed; (4) elimination of end effects such as edge bead trim and nonuniform temperature that may result from flat die film extrusion; and (5) capability of biaxial orientation (allowing uniformity of mechanical properties).

As part of the process, a melt comprising a polyethylene (or blend thereof) may be mixed with a foaming agent and extruded through an annular slit die to form a thin-walled tube. Air may be introduced via a hole in the center of the die to blow up the tube like a balloon. Mounted on top of the die, a high-speed air ring blows onto the hot film to cool it. The foam film may be drawn in an upward direction, continually cooling, until it passes through nip rolls where the tube is flattened to create what is known as a “lay-flat” tube of film. This lay-flat or collapsed tube may then be taken back down the extrusion tower via more rollers. For high output lines, air inside the bubble may also be exchanged. The lay-flat film may be either wound or the edges of the film may be slit off to produce two flat film sheets and wound up onto reels to produce a tube of film. For lay-flat film, the tube may be made into bags, for example, by sealing across the width of film and cutting or perforating to make each bag. This operation may be performed either in line with the blown film process or later. The blown film extrusion process is typically a continuous process.

In coextrusion lines, the number of extruders depends on the number of different materials being extruded and not necessarily on the number of layers. Current feedblock technology allows fluid flow from one extruder to be split into two or more layers in the coextrudate. In an aspect, a coextrusion feedblock arranges the different melt streams in a predetermined layer sequence and generates a melt stream for each layer. Each melt stream then meets its neighboring layers and a final planar coextrudate is formed. The coextrusion feedblock may be fixed or have variable geometry blocks. A flat die, and the synergy between the die and the feedblock, are crucial to high-quality film production. The die must spread the coextrudate received from the feedblock while maintaining flatness of the film. The die requires a sufficiently short residence time to prevent heat transfer between layers or polymer degradation. The die must also be strong enough to resist deformation when subjected to high pressures inherent in thin film processes. In an aspect, the present multilayer films may have 7 total layers or fewer, such as 3, 4, 5, 6, or 7 layers. More layers may be employed within the spirit of the present disclosure; for instance, in a broader aspect, the present multilayer films may have 50 total layers or fewer. In some embodiments, films of the present disclosure are oriented in the Machine Direction (MD) at a draw down ratio of up to 25 and a blow-up ratio of 2.5.

### Film Properties

Films of the present disclosure may also or instead exhibit one or more, two or more, or even all of the following properties:

Film Thickness-Films according to various embodiments may have a film thickness value of about K1 to about K2, where K1 and K2 may be, independently, 0.05 mil (~1.27 μm), 0.1 mil, 0.2 mil, 0.3 mil, 0.4 mil, 0.5 mil, 0.6 mil, 0.7 mil, 0.8 mil, 0.9 mil, 1 mil, 1.1 mil, 1.2 mil, 1.3 mil, 1.4 mil, 1.5 mil, 1.6 mil, 1.7 mil, 1.8 mil, 1.9 mil, 2 mil (~51 μm), 3 mil, 4 mil, 5 mil, or 6 mil (~152 μm), and wherein K1<K2. For example, the film thickness may range from about 0.05 mil to about 6 mil, or about 0.4 mil to about 6 mil, or about 1 mil to about 6 mil, or about 0.05 mil to about 5 mil, or about 0.1 mil to about 4 mil, or about 0.4 mil to about 3 mil, or about 0.7 mil to about 2 mil, or about 0.8 mil to about 1.5 mil.

Yield strength (psi) in the machine direction (yield strength (MD)) (according to ASTM D882)—Films according to various embodiments may have yield strength (MD) value of about L1 to about L2, where L1 and L2 may be, independently, 2000 psi, 2,000 psi; 2,100 psi; 2,200 psi; 2,300 psi; 2,400 psi; 2,500 psi; 2,600 psi; 2,700 psi; 2,800 psi; 2,900 psi; 3,000 psi; 3,100 psi; 3,200 psi; 3,300 psi; 3,400 psi; 3,500 psi; 3,600 psi; 3,700 psi; 3,800 psi; 3,900 psi; 4,000 psi; 4,100 psi; 4,200 psi; 4,300 psi; 4,400 psi; 4,500 psi; 4,600 psi; 4,700 psi; 4,800 psi; 4,900 psi; or 5,000 psi, and wherein L1<L2. For example, the yield strength (MD) may range from about 2,000 to 5,000 psi, or 2,500 psi to about 3,000 psi, about 3,000 to about 3,500 psi, or about 3,500 to about 4,000 psi, about 4,000 to about 4,500, or about 4,500 to about 5,000 psi.

Yield strength in the transverse direction (yield strength (TD)) (according to ASTM D882)—Films according to various embodiments may have a yield strength (TD) value of about M1 to about M2, where M1 and M2 may be, independently, 2000 psi, 2,000 psi; 2,100 psi; 2,200 psi; 2,300 psi; 2,400 psi; 2,500 psi; 2,600 psi; 2,700 psi; 2,800 psi; 2,900 psi; 3,000 psi; 3,100 psi; 3,200 psi; 3,300 psi; 3,400 psi; 3,500 psi; 3,600 psi; 3,700 psi; 3,800 psi; 3,900 psi; 4,000 psi; 4,100 psi; 4,200 psi; 4,300 psi; 4,400 psi; 4,500 psi; 4,600 psi; 4,700 psi; 4,800 psi; 4,900 psi; or 5,000 psi, and wherein M1<M2. For example, the yield strength (TD) may range from about 2,000 to 5,000 psi, or 2,500 psi to about 3,000 psi, about 3,000 to about 3,500 psi, or about 3,500 to about 4,000 psi, about 4,000 to about 4,500, or about 4,500 to about 5,000 psi).

Elongation (%) at Yield-Films according to various embodiments may have an elongation at yield value of about N1 to about N2, where N1 and N2 may be, independently, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10%, and wherein N1<N2. For example, the elongation (%) at yield may range from about 1% to about 10%, or about 1% to about 3%, or about 1.5% to about 3.5%, or about 2% to about 4%, or about 2.5% to about 4.5%, or about 3% to about 5%, or about 3.5% to about 5.5%, or about 4% to about 6%, or about 4.5% to about 6.5%, or about 5% to about 7%, or about 5.5% to about 7.5%, or about 6% to about 8%, or about 6.5% to about 8.5%, or about 7% to about 9%, or about 7.5% to about 9.5%, or about 8% to about 10%.

Tensile strength (psi) in the machine direction (tensile strength (MD)) (according to ASTM D882)—Films according to various embodiments may have a tensile strength (MD) value of about 01 to about 02, where 01 and 02 may be, independently, 2,000 psi; 2,500 psi; 3,000 psi; 3,500 psi; 4,000; 4,500; 5,000; 5,500; 6,000; 6,500; 7,000; 7,500; 8,000; 8,500; 9,000; 9,500; 10,000; 10,500 psi; 11,000 psi; 11,500 psi; 12,000 psi; 12,500 psi; 13,000 psi; 13,500 psi; 14,000 psi, 14,500 psi, or 15,000 psi, and wherein 01<02. For example, the tensile strength (MD) may range from about 2,000 psi to about 15,000 psi, or 4,000 psi to about 4,500 psi; or about 4,500 psi to about 5,000 psi; or about 5,000 psi to about 5,500 psi; or about 5,500 psi to about 6,000 psi; or about 6,000 psi to about 6,500 psi; or about 6,500 psi to about 7,000 psi; or about 7,000 psi to about 7,500 psi; or about 8,000 psi to about 8,500 psi.

Tensile strength (psi) in the transverse direction (tensile strength (TD)) (according to ASTM D882)—Films according to various embodiments may have a tensile strength (TD) value of about P1 to about P2, where P1 and P2 may be, independently, 2,000 psi; 2,500 psi; 3,000 psi; 3,500 psi; 4,000; 4,500; 5,000; 5,500; 6,000; 6,500; 7,000; 7,500; 8,000; 8,500; 9,000; 9,500; 10,000; 10,500 psi; 11,000 psi; 11,500 psi; 12,000 psi; 12,500 psi; 13,000 psi; 13,500 psi; 14,000 psi, 14, 500 psi, or 15,000 psi, and wherein P1<P2. For example, the tensile strength (TD) may range from about 2,000 psi to about 15,000 psi, or 4,000 psi to about 4,500 psi; or about 4,500 psi to about 5,000 psi; or about 5,000 psi to about 5,500 psi; or about 5,000 psi to about 7,500 psi; or about 5,500 psi to about 6,000 psi; or about 6,000 psi to about 6,500 psi; or about 6,500 psi to about 7,000 psi; or about 7,000 psi to about 7,500 psi.

1% secant modulus (psi) in the machine direction (1% SM (MD)) (according to ASTM D882)—Films according to various embodiments may have a 1% SM (MD) value of about Q1 to about Q2, where Q1 and Q2 may be, independently, 90,000 psi; 95,000 psi; 100,000 psi; 105,000 psi; 110,000 psi; 115,000 psi; 120,000 psi; 125,000 psi; 130,000 psi; 135,000 psi; 140,000 psi; 145,000 psi; or 150,000 psi, and wherein Q1<Q2. For example, the 1% SM (MD) may range from about about 90,000 psi to about 150,000 psi, such as about 90,000 psi to about 95,000 psi; or about 95,000 psi to about 100,0000 psi; or about 100,000 psi to about 105,000 psi; or about 105,000 psi to about 110,000 psi; or about 110,000 psi to about 115,000 psi; or about 115,000 psi to about 120,000 psi; or about 120,000 psi to about 125,000 psi; or about 125,000 psi to about 130,000 psi; or about 130,000 psi to about 135,000 psi; or about 135,000 psi to about 140,000 psi; or about 140,000 psi to about 145,000 psi; or about 145,000 psi to about 150,000 psi.

1% secant modulus (psi) in the transverse direction (1% SM (TD)) (according to ASTM D882)—Films according to various embodiments may have a 1% SM (TD) value of about R1 to about R2, where R1 and R2 may be, independently, 90,000 psi; 95,000 psi; 100,000 psi; 105,000 psi; 110,000 psi; 115,000 psi; 120,000 psi; 125,000 psi; 130,000 psi; 135,000 psi; 140,000 psi; 145,000 psi; or 150,000 psi, and wherein Q1<Q2. For example, the 1% SM (TD) may range from about 90,000 psi to about 150,000 psi, such as about 90,000 psi to about 95,000 psi; or about 95,000 psi to about 100,0000 psi; or about 100,000 psi to about 105,000 psi; or about 105,000 psi to about 110,000 psi; or about 110,000 psi to about 115,000 psi; or about 115,000 psi to about 120,000 psi; or about 120,000 psi to about 125,000 psi; or about 125,000 psi to about 130,000 psi; or about 130,000 psi to about 135,000 psi; or about 130,000 psi to about 150,000 psi; or about 135,000 psi to about 140,000 psi; or about 140,000 psi to about 145,000 psi; or about 145,000 psi to about 150,000 psi.

Elmendorf Tear value in the machine direction (Elmendorf Tear (MD)) (grams force per mil (g/mil)), in accordance with ASTM D1922 (with conditioning for 40 hours at 23° C.±2° C. and 50%+10% relative humidity)—Films according to various embodiments may have Elmendorf Tear (MD) value of about S1 to about S2, where S1 and S2 may be, independently, 10 g/mil, 11 g/mil, 12 g/mil, 13 g/mil, 14 g/mil, 15 g/mil, 16 g/mil, 17 g/mil, 18 g/mil, 19 g/mil, 20 g/mil, 21 g/mil, 22 g/mil, 23 g/mil, 24 g/mil, 25 g/mil, 26 g/mil, 27 g/mil, 28 g/mil, 29 g/mil, 30 g/mil, 31 g/mil, 32 g/mil, 33 g/mil, 34 g/mil, 35 g/mil, 36 g/mil, 37 g/mil, 38 g/mil, 39 g/mil, or 40 g/mil, and wherein S1<S2. For example, the Elmendorf Tear (MD) may range from about 10 g/mil to about 40 g/mil, or about 10 g/mil to about 20 g/mil, or about 15 g/mil to about 25 g/mil, or about 20 g/mil to about 30 g/mil, or about 25 g/mil to about 35 g/mil, or about 30 g/mil to about 40 g/mil.

Elmendorf Tear value in the transverse direction (Elmendorf Tear (TD))—Films according to various embodiments may have Elmendorf Tear (TD) value of about T1 to about T2, where h1 and h2 may be, independently, 50 g/mil, 55 g/mil, 60 g/mil, 65 g/mil, 70 g/mil, 75 g/mil, 80 g/mil, 85 g/mil, 90 g/mil, 95 g/mil, 100 g/mil, 105 g/mil, 110 g/mil, 115 g/mil, 120 g/mil, 125 g/mil, 130 g/mil, 135 g/mil, 140 g/mil, 145 g/mil, 150 g/mil, 155 g/mil, 160 g/mil, 165 g/mil, 170 g/mil, 175 g/mil, 180 g/mil, 185 g/mil, 190 g/mil, 195 g/mil, or 200 g/mil, and wherein T1<T2. For example, the Elmendorf Tear (TD) may range from about 50 g/mil to about 300 g/mil, or about 50 g/mil to about 150 g/mil, or about 60 g/mil to about 160 g/mil, or about 70 g/mil to about 170 g/mil, or about 80 g/mil to about 180 g/mil, or about 90 g/mil to about 190 g/mil, or about 100 g/mil to about 200 g/mil, or about 50 g/mil to about 100 g/mil, or about 60 g/mil to about 110 g/mil, or about 70 g/mil to about 120 g/mil, or about 80 g/mil to about 130 g/mil, or about 90 g/mil to about 140 g/mil, or about 100 g/mil to about 150 g/mil, or about 110 g/mil to about 160 g/mil, or about 120 g/mil to about 170 g/mil, or about 130 g/mil to about 180 g/mil, or about 140 g/mil to about 190 g/mil, or about 150 g/mil to about 200 g/mil).

Water Vapor Transmission Rate (WVTR) value-Films with approximately a 1 mil thickness according to various embodiments may have a WVTR value of about U1 to about U2, where U1 and U2 may be, independently, 1 grams per mil per square meters per day (g·mil/m²·day), 2 g·mil/m²·day, 3 g·mil/m²·day, 4 g·mil/m²·day, 5 g·mil/m²·day, 6 g·mil/m²·day, 7 g·mil/m²·day, 8 g·mil/m²·day, 9 g·mil/m²·day, 10 g·mil/m²·day, 11 g·mil/m²·day, 12 g·mil/m²·day, 13 g·mil/m²·day, 14 g·mil/m²·day, 15 g·mil/m²·day, 16 g·mil/m²·day, 17 g·mil/m²·day, 18 g·mil/m²·day, 19 g·mil/m²·day, 20 g·mil/m²·day, 21 g·mil/m²·day, 22 g·mil/m²·day, 23 g·mil/m²·day, 24 g·mil/m²·day, or 25 g·mil/m²·day, and wherein U1<U2. For example, the WVTR may range from about 10 g·mil/m²·day to about 20 g·mil/m²·day, or about about 12 g·mil/m²·day to about 17 g·mil/m²·day, or about 1 g·mil/m²·day to about 10 g·mil/m²·day, or about 2 g·mil/m²·day to about 8 g·mil/m²·day, or about 3 g·mil/m²·day to about 7 g·mil/m²·day, or about 4 g·mil/m²·day to about 7 g·mil/m²·day, or about 5 g·mil/m²·day to about 7 g·mil/m²·day. For WVTR measurements, film samples are cut into 10 cm×10 cm samples and the exposed area for testing is 50 cm². Five (5) thickness measurements are made and the average of the 5 measurements is used for the WVTR calculation. Testing is performed at 37.8° C. and the remaining testing procedures are per ASTM F1249.

Oxygen Transmission rate (OTR) value-Films according to various embodiments may have an OTR value of about V1 to about V2, where V1 and V2 may be, independently, 50, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210 215, 220, 225, 230, 235, 240, 245, or 250 cubic centimeters per mil per 100 square inches per day (cm³·mil/100 in²·day), and wherein V1<V2. For example, the OTR may range from about 50 to about 250 cm³·mil/100 in²·day, or about 50 to about 80 cm³·mil/100 in²·day, or about 80 to about 110 cm³·mil/100 in²·day, or about 110 to about 140 cm³·mil/100 in²·day, or about 140 to about 170 cm³·mil/100 in²·day, or about 170 to about 200 cm³·mil/100 in²·day, or about 80 to about 210 cm³·mil/100 in²·day, or about 100 to about 200 cm³·mil/100 in²·day, or about 150 to about 200 cm³·mil/100 in²·day. For oxygen transmission measurements, ASTM D3985 was followed.

Haze (%)—Films according to various embodiments may have a haze value, as determined by ASTM D1003-13, of about W1 to about W2, where W1 and W2 may be, independently, 5%, 6%, 7%, 8%, 9%, 10%, 11%, 12%, 13%, 14%, 15, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50%, and wherein W1<W2. For example, the haze may range from about 5% to about 50%, or about 10% to about 45%, or about 15% to about 40%, or about 20% to about 35%, or about 25% to 30%, or about 25% to about 50%, or about 30% to 45%.

### Molded Articles

Molded articles produced according to processes described herein, such as blow molding, injection molding and rotary molding, may have single or multi-layered constructions and may be used in bottles, tanks, large hollow articles, rigid food containers and toys, etc.

Molded articles according to various embodiments may comprise one or more polyethylenes and/or polyethylene blends described herein. In certain embodiments, molded articles further comprise up to about 50 wt. % of recycled polyethylene.

### Blow Molded Articles

Polyethylenes and/or polyethylene blends thereof described herein are also suitable for use in blow molding processes. Such processes are well known in the art, and involve a process of inflating a hot, hollow thermoplastic preform (or parison) inside a closed mold. In this manner, the shape of the parison conforms to that of the mold cavity, enabling the production of a wide variety of hollow parts and containers.

In a typical blow molding process, a parison is formed between mold halves and the mold is closed around the parison, sealing one end of the parison and closing the parison around a mandrel at the other end. Air is then blown through the mandrel (or through a needle) to inflate the parison inside the mold. The mold is then cooled and the part formed inside the mold is solidified. Finally, the mold is opened, and the molded article is ejected. The process lends itself to any design having a hollow shape, including but not limited to bottles, tanks, toys, household goods, automobile parts, and other hollow containers and/or parts.

Blow molding processes may include extrusion and/or injection blow molding. Extrusion blow molding is typically suited for the formation of items having a comparatively heavy weight, such as greater than about 12 ounces, including but not limited to food, laundry, or waste containers. Injection blow molding is typically used to achieve accurate and uniform wall thickness, high quality neck finish, and to process polymers that cannot be extruded. Typical injection blow molding applications include, but are not limited to, pharmaceutical, cosmetic, and single serving containers, typically weighing less than 12 ounces.

### Rotational Molded Articles

Polyethylenes and polyethylene blends described herein are also suitable for use in rotational molding processes. Rotational molding or rotational casting, more commonly known as rotomolding, is widely used for molding hollow articles, and can be used to mold both small and large containers, such as tanks of typically 19 L to 57,000 L. Such rotomolded tanks are utilized in agricultural, chemical, and recreational vehicle industries. Rotomolded containers are used for packaging and material handling, particularly as container articles for fluids, non-liquids or solids. Rotational molding is also used for portable toilets, instrument and battery cases, light globes, vacuum cleaner and scrubber housings, toys, and garbage containers. The process is relatively less expensive and easy to use for polymer processing than other known means and has been increasing in use.

To rotomold a part, polymeric resin, usually in powder, or micropellet form, or combinations thereof, is charged inside a mold shell, which is then typically rotated on two axes and heated to cause the melting resin to adhere to the inside of the mold. After sufficient heating time, the mold is moved to a cooling chamber, and after cooling, the molded article is removed to begin another molding cycle. More detailed discussion of rotomolding may be found in Modern Plastics Encyclopedia, 1990, pp. 317-318, and in Encyclopedia of Polymer Science and Engineering, pp. 659-670, J. Wiley & Sons, 1990.

Rotational molding primarily uses polyolefin resins, with thermoplastic polymers of ethylene being principally used. Key properties for rotomolded articles include appearance, and especially in the case of containers, resistance to puncture or rupture, chemical resistance and for extended periods of usefulness, resistance to environmental stress cracking. Low density polyethylene (LDPE) with a density of about 0.900 to about 0.925 g/cm³, linear low density polyethylene (LLDPE) with a density of about 0.926 to about 0.940 g/cm³, and high density polyethylene (HDPE) with a density of about 0.940 to about 0.960 g/cm³ are used in rotomolding applications. LLDPE is said to be preferred for its excellent low temperature impact strength and good environmental stress crack resistance (“ESCR”).

### Injection Molded Articles

Polyethylenes and polyethylene blends described herein are also suitable for use in forming injection molded articles. Injection molding is a process commonly known in the art and is a process that usually occurs in a cyclical fashion. Cycle times generally range from 10 to 100 seconds and are controlled by the cooling time of the polymer or polymer blend used. In a typical injection molding cycle, polymer pellets or powder are fed from a hopper and melted in a reciprocating screw type injection molding machine. The screw in the machine rotates forward, filling a mold with melt and holding the melt under high pressure. As the melt cools in the mold and contracts, the machine adds more melt to the mold to compensate. Once the mold is filled, it is isolated from the injection unit and the melt cools and solidifies. The solidified part is ejected from the mold and the mold is then closed to prepare for the next injection of melt from the injection unit. Injection molding processes offer high production rates, good repeatability, minimum scrap losses, and little to no need to further finish the parts.

Injection molding is suitable for a wide variety of applications, including containers, household goods, automobile components, electronic parts, and many other solid articles. Injection molded containers for non-food applications (pails, waste carts, trash containers, storage containers, etc.) have been historically injection molded from LLDPE and HDPE Ziegler-Natta catalyzed resins. It has been found that injection molding LLDPE and HDPE resins made from the inventive polymers and polyethylene blends described herein dramatically improves balances of processability and physical properties when compared to Ziegler-Natta counterparts.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

### EXAMPLE EMBODIMENTS

The present disclosure is further directed to the following non-limiting embodiments.

Embodiment 1. A polyethylene comprising: (a) a resin density of about 0.950 grams/cubic centimeter (g/cm³) to about 0.960 g/cm³, as measured in accordance with ASTM D1505; (b) a melt index at 2.16 kg loading and 190° C. of about 0.5 grams/10 minutes (g/10 min) to about 2 g/10 min, as measured in accordance with ASTM D1238; (c) a high load melt index at 21.6 kg loading and 190° C. of about 15 g/10 min to about 28 g/10 min, as measured in accordance with ASTM D1238; (d) a polydispersity index of about 3 or less, as measured by gel permeation chromatography; and (e) a crystallization peak width at half height of about 5° C. or less, as measured in accordance with ASTM D3418.

Embodiment 2. The polyethylene of Embodiment 1, wherein the polyethylene is a polyethylene homopolymer.

Embodiment 3. The polyethylene of Embodiment 1 or Embodiment 2, further comprising: a melt index at 2.16 kg loading and 190° C. of about 1.2 grams/10 minutes (g/10 min) to about 2 g/10 min, as measured in accordance with ASTM D1238.

Embodiment 4. The polyethylene of any one of Embodiments 1 to 3, further comprising: a melt index ratio of about 12 to about 17, as measured in accordance with ASTM D1238.

Embodiment 5. The polyethylene of any one of Embodiments 1 to 4, further comprising: a polydispersity index of about 2 to about 3, as measured by gel permeation chromatography.

Embodiment 6. The polyethylene of any one of Embodiments 1 to 5, further comprising: a crystallization peak width at half height of about 3° C. to about 5° C. as measured by DSC in accordance with ASTM D3418.

Embodiment 7. The polyethylene of any one of Embodiments 1 to 6, further comprising: a crystallization maximum peak height×100 to a crystallization enthalpy ratio having an absolute value of about 2.5 to about 2.8 W/J, as measured by differential scanning calorimetry in accordance with ASTM D3418.

Embodiment 8. The polyethylene of any one of Embodiments 1 to 7, further comprising: a ratio of z-average molecular weight to weight-average molecular weight of about 2 or less, as measured by gel permeation chromatography.

Embodiment 9. The polyethylene of any one of Embodiments 1 to 8, further comprising: a ratio of z-average molecular weight to weight-average molecular weight of about 1.5 to about 2, as measured by gel permeation chromatography.

Embodiment 10. The polyethylene of any one of Embodiments 1 to 9, further comprising: a vinyl carbon to 1000 total carbon ratio of about 0.1 to about 0.2, as measured by proton nuclear magnetic resonance (¹H NMR) spectroscopy.

Embodiment 11. The polyethylene of any one of Embodiments 1 to 10, further comprising: a single peak melting temperature of about 133° C. to about 134° C., as measured by differential scanning calorimetry in accordance with ASTM D3418.

Embodiment 12. The polyethylene of any one of Embodiments 1 to 11, further comprising: an Eta0 of about 4000 Pa·s to about 7000 Pa·s, according to the Carreau-Yasuda model of complex viscosity values, as measured at 190° C. using a parallel plate rheometer at 0.01 rad/s to 698 rad/s angular frequency; and/or a strain ratio of about 10 or less, as measured at 190° C. using a parallel plate rheometer at 0.01 rad/s and 100 rad/s angular frequency.

Embodiment 13. The polyethylene of any one of Embodiments 1 to 12, further comprising: an IZOD impact strength at −40° C. of about 3 or greater foot-pounds per inch (ft-1b/in), as measured in accordance with ASTM D256; and/or an IZOD impact at −40° C. of about 5 or greater foot-pounds per inch (ft-lb/in), as measured in accordance with ASTM D256, and a Charpy impact strength at 23° C. of about 25 or greater kilojoules per square meter (KJ/m²), as measured in accordance with ISO 179.

Embodiment 14. A polyethylene film comprising a polyethylene of any one of Embodiments 1 to 13, further comprising a film density greater than 0.944 grams/cubic centimeter (g/cm³).

Embodiment 15. The polyethylene film of Embodiment 14, further comprising a film density less than 0.953 grams/cubic centimeter (g/cm³).

Embodiment 16. The polyethylene film of Embodiment 14 or Embodiment 15, wherein the polyethylene film lacks a nucleating agent, and the polyethylene film has a water vapor transmission rate of about 7 or less grams per mil per square meter per day (g·mil/m²·day), as measured in accordance with ASTM-F1249.

Embodiment 17. The polyethylene film of Embodiment 14 or Embodiment 15, wherein the polyethylene film further comprises a nucleating agent, and the polyethylene film has a water vapor transmission rate of 4 or less g·mil/m²·day.

Embodiment 18. The polyethylene film of any one of Embodiments 14-16, wherein the polyethylene film lacks a nucleating agent, and the polyethylene film has an oxygen transmission rate of about 190 cubic centimeters per mil per 100 square inches per day (cm³·mil/100 in²·day) to about 210 cm³·mil/100 in²·day, as measured in accordance with ASTM D3985.

Embodiment 19. The polyethylene film of any one of Embodiments 14-15 or 17, wherein the polyethylene film further comprises a nucleating agent, and the polyethylene film has an oxygen transmission rate of about 80 to 90 cubic centimeters per mil per 100 square inches per day (cm³·mil/100 in²·day), as measured in accordance with ASTM D3985.

Embodiment 20. The polyethylene film of any one of Embodiments 14 to 19, wherein the polyethylene film exhibits: an elongation at break in the machine direction of about 600% or greater, as measured in accordance with ASTM D882; and/or an elongation at break in the transverse direction of about 600% or greater, as measured in accordance with ASTM D882.

Embodiment 21. The polyethylene film of any one of Embodiments 14 to 20, wherein the polyethylene film exhibits: a 1% secant modulus in the machine direction of about 100 or greater kilopounds per square inch (kpsi); and/or a 1% secant modulus in the transverse direction of about 130 or greater kpsi, as measured in accordance with ASTM D882.

Embodiment 21. A multi-layered film comprising at least one layer of the polyethylene film of any one of Embodiments 14 to 20.

Embodiment 22. A molded article comprising the polyethylene of any one of Embodiments 1 to 13.

Embodiment 23. The molded article of Embodiment 22, further comprising up to about 50 weight percent (wt %) of recycled polyethylene.

Embodiment 24. A method comprising: combining ethylene with a catalyst system in a slurry loop reactor, the catalyst system comprising: (i) bis(n-propylcyclopentadienyl) zirconium dichloride; (ii) a support material; and (iii) an activator; and obtaining the polyethylene of any one of Embodiments 1 to 13.

Embodiment 25. The method of Embodiment 24, wherein the slurry loop reactor is a single slurry loop reactor.

### EXAMPLES

### Polymerization Process Description

Polyethylenes of the present disclosure were prepared in a single slurry loop reactor with ethylene as the only monomer using the polymerization catalyst: bis(n-propylcyclopentadienyl) zirconium dichloride supplied on a support having an activator. The reactor conditions are included in Table 1 below, where reactor temperature, ethylene concentration, and hydrogen concentration were varied to produce Inventive Examples 1, 2, and 3 (“IE1,” “IE2,” and “IE3,” respectively). Hydrogen is a chain transfer agent that adjusts the molecular weight of the polymer.

TABLE 1

| Slurry Loop | | | |
|---|---|---|---|
| Reactor Conditions | Inventive Examples | | |
| Reactor Temperature | 207-215° F. (92-102° C.) | | |
| Reactor Pressure | 550 psig | | |
| Ethylene concentration | 4.0-4.5 wt. % excess | | |
| H₂ concentration | IE1: | IE2: 1-5 | IE3: |
| | N/A | ppm vs. | N/A |
| | | ethylene | |
| | | feed rate | |

| | |
|---|---|
| Solvent | Isobutane |
| Solids | 36-37 wt. % |

### Resin Characterizations and Tests

In Tables 2A-2E, inventive examples (IE1, IE2, and IE3), produced as described above, are described in reference to control examples (i.e., commercially available HDPE polymers, CE1 (ExxonMobil™ HDPE HTA108, unimodal), CE2 (NOVA 167, bimodal), CE3 (ExxonMobil™ HDPE HD7845, bimodal), CE4 (ExxonMobil Experimental HDPE-FA010, unimodal), CE5 (ExxonMobil Experimental HDPE-HDZ269, bimodal), and CE6 (ExxonMobil™ HDPE HD6706, unimodal)). In connection with these properties and the discussion of these examples, the following test methods should be referenced.

Density values were determined by displacement method according to ASTM D1505.

Melt index (2.16 kg) and High Load Melt index (21.6 kg) values were determined according to ASTM D1238 procedure B, such as by using a Gottfert MI-2 series melt flow indexer. Rheology data was determined using a TA Instrument model ARES-G2B via small amplitude oscillatory shear (SAOS) testing at 190° C. The rheology testing specimens were compression molded using a press into a shape having a diameter of 25 mm and a thickness of about 1.5 mm. The rheology specimens were preheated to 190° C., and the rheology testing temperature was equilibrated at 190° C. for 5 minutes prior to testing. The rheology testing frequency was from 0.01 to 638 rad/s, and the oscillation strain was about 5% strain during the test. Rheology data for Inventive Examples 1-3 and Comparative Examples 1-5 are given in Table 2A.

TABLE 2A

| | CE1 | CE2 | CE3 | CE4 | CE5 | IE1 | IE2 | IE3 |
|---|---|---|---|---|---|---|---|---|
| MI2 | 0.74 | 1.25 | 0.46 | 0.75 | 1.8 | 1.51 | 1.39 | 1.27 |
| (g/10 min) | | | | | | | | |
| HLMI | 47.5 | 67.6 | 30 | 56.6 | 107 | 24.6 | 21.9 | 20 |
| (g/10 min) | | | | | | | | |
| MIR | 64.2 | 54.1 | 65.2 | 75.5 | 58 | 16.3 | 15.8 | 15.9 |
| Resin Density | 0.961 | 0.968 | 0.958 | 0.963 | 0.953 | 0.954 | 0.953 | 0.953 |
| (g/cm³) | | | | | | | | |

Molecular weight data (Mz, Mn, Mw) was determined according to GPC method for Inventive Examples 1-3 and Comparative Examples 1~4 with results presented in Table 2B. In particular, the values were obtained by using a high temperature Gel Permeation Chromatography (Polymer Char GPC-IR) equipped with a multiple-channel band-filter based infrared detector (IR5), an 18-angle light scattering detector and a viscometer. Three Agilent PLgel 10 μm Mixed-B LS columns were used to provide polymer separation. Detailed analytical principles, parameters, and methods are described in W02019-246069A1. The disclosed Mz, Mn, Mw values and moments thereof are based on absolute method. The unimodal molecular weight distributions of Comparative Examples 1 and 4 and Inventive 10 Examples 1-3 were confirmed by the presence of a single distinguishable peak in the molecular weight distribution curve, while bimodal molecular weight distributions of Comparative Examples 2 and 3 were confirmed by the presence of two distinguishable peaks in the molecular weight distribution curves.

TABLE 2B

| | CE1 | CE2 | CE3 | CE4 | IE1 | IE2 | IE3 |
|---|---|---|---|---|---|---|---|
| Mn | 11,058 | 9,991 | 17,954 | 15,964 | 41,981 | 42,875 | 43,917 |
| (LS) | | | | | | | |
| Mw | 144,297 | 104,757 | 240,964 | 125894 | 105,458 | 107,114 | 111,379 |
| (LS) | | | | | | | |
| Mz | 1.14E6 | 314,750 | 1.45E6 | 926,768 | 187,384 | 118,121 | 196,132 |
| (LS) | | | | | | | |
| Mw/ | 13.0 | 10.5 | 13.4 | 7.9 | 2.5 | 2.5 | 2.5 |
| Mn | | | | | | | |
| Mz/ | 7.9 | 3.0 | 6.0 | 7.4 | 1.8 | 1.8 | 1.8 |
| Mw | | | | | | | |
| g′ | 0.96 | 1.0 | 0.74 | 0.94 | 1.00 | 1.00 | 1.00 |
| Mw^{3.4} | 3.48E17 | 1.17E17 | 1.99E18 | 2.19E17 | 1.20E17 | 1.26E17 | 1.44E17 |
| Eta0/ | 7.2E−13 | 9.3E−14 | 2.9E−14 | 4.0E−12 | 4.3E−14 | 4.4E−14 | 4.4E−14 |
| Mw^{3.4} | | | | | | | |

Thermal analysis DSC was performed according to ASTM D3418. The sample size was approximately 6 to 8 mg and detailed sequence was the following: 1: Sampling interval 0.50 s/pt; 2: Equilibrate at −20.00° C.; 3: Isothermal for 5.00 min; 4: Mark end of cycle 1; 5: Ramp 10.00° C./min to 200.00° C.; 6: Isothermal for 5.00 min; 7: Mark end of cycle 2; 8: Ramp 10.00° C./min to −20.00° C.; 9: Isothermal for 5.00 min; 10: Mark end of cycle 3; 11: Ramp 10.00° C./min to 200.00° C.; 12: Isothermal for 1.00 min; 13: Mark end of cycle 4. The degree of crystallinity was calculated from the DSC thermogram using the following expression (Hristov and Vasileva 2003), Xc=ΔH/ΔH0×100%, where ΔH is the heat of fusion of the 2nd melt (J/g), and ΔH0 is the heat of fusion of 100% crystalline HDPE, which is taken to be 293 J/g according to Na et al. (2002). The maximum height of crystallization peak was multiplied by 0.5 to obtain the half height of the crystallization peak. The difference between the 2 temperatures of each crystallization peak at this half height is defined as crystallization peak width at half height (PWHH), which in general reflects the distribution of crystal size of the polymer. DSC results for Inventive Examples 1-3 and Comparative Examples 1-5 are given in Table 2C.

TABLE 2C

| | CE1 | CE2 | CE3 | CE4 | CE5 | IE1 | IE2 | IE3 |
|---|---|---|---|---|---|---|---|---|
| Tₘ | 134.4 | 134.8 | 133.2 | 134.9 | 129.5 | 133.5 | 133.8 | 133.6 |
| (2^{nd} melt) | | | | | | | | |
| ΔHc | 228.6 | 241.0 | 219.7 | 211.8 | 188.2 | 214.2 | 209.2 | 207.5 |
| (J/g) | | | | | | | | |
| MPH | −3.06 | −3.81 | −4.57 | −3.74 | −3.00 | −5.74 | −5.33 | −5.70 |
| (W/g) | | | | | | | | |
| MPH × | −1.34 | −1.581 | −2.08 | −1.766 | −1.594 | −2.680 | −2.548 | −2.747 |
| 100/ΔHc | | | | | | | | |
| (W/J) | | | | | | | | |
| PWHH | 10.5 | 8.2 | 5.4 | 8.2 | 8.5 | 4.2 | 4.5 | 4.1 |
| (° C.) | | | | | | | | |
| ΔHf | 227.7 | 245.2 | 220.4 | 219.6 | 196.3 | 213.2 | 208.3 | 206.7 |
| (J/g) | | | | | | | | |
| Xc % | 77.7 | 83.7 | 75.2 | 74.9 | 67.0 | 72.8 | 71.1 | 70.5 |

The DSC data in Table 2C and FIG. 1 (showing the crystallization peak of the examples) clearly show that all of the inventive examples have narrower crystallization peaks than the comparative examples. The crystallization peak width at half height of inventive examples are all less than 5° C. while the crystallization peak width at half height of all comparative examples are greater than 5° C. The narrow crystallization peak is believed to be related to the narrow crystal size distribution. Without being bound by theory, it is believed that, during the film extrusion process, the narrow crystal size distribution leads to a more isotropic orientation, as reflected by the balanced MD/TD elongation at break and tear strength, and a longer and smaller pathway for moisture across the film thickness, i.e., a lower moisture permeation rate. In addition, it is believed that the absence of large sized crystals also contributes to a lower haze of the film.

Complex viscosity, referred to herein as “Eta” was determined using SAOS (small amplitude oscillatory shear) testing at 190° C. using a 25 mm parallel plate configuration on an ARES-G2B (TA Instruments). Sample test disks (25 mm diameter, 1.5 mm thickness) were made with a Carver Laboratory press at 190° C. Samples were allowed to sit without pressure for approximately 5 minutes in order to melt and then held under pressure typically for 3 minutes to compression mold the sample. The disk sample was first equilibrated at 190° C. for about 10 minutes between the parallel plates in the rheometer to erase any prior thermal and crystallization history. An angular frequency sweep was performed with a measurement gap of 1.5 mm from 628 rad/s to 0.01 rad/s angular frequency using 5 points/decade and a strain value within the linear viscoelastic region determined from strain sweep experiments, e.g., about 5% strain (see C. W. Macosko, Rheology Principles, Measurements and Applications, Wiley-VCH, New York, 1994). All experiments were performed in a nitrogen atmosphere to minimize any degradation of the sample during the rheological testing. The complex viscosity |η*(ω)| versus frequency (ω) data obtained for the SAOS experiment was fitted using the Carreau-Yasuda (CY) model to obtain the zero-shear viscosity (i.e., the viscosity in the limit of zero shear rate), alternately referred to herein as “no” or “Eta0”, using TA instrument TRIOS software. Table 2D presents the results of complex viscosity analysis for Inventive Examples 1-3 and Comparative Examples 1-5. Table 2D also presents results of crossover measurements (crossover frequency and crossover modulus) for Inventive Examples 1-3 and Comparative Examples 1-4.

TABLE 2D

| SAOS | | | | | | | | |
|---|---|---|---|---|---|---|---|---|
| Data | CE1 | CE2 | CE3 | CE4 | CE5 | IE1 | IE2 | IE3 |
| Eta@0.01 | 32,914 | 9,268 | 32,868 | 42,226 | 10,146 | 5,158 | 5,616 | 6,325 |
| Eta@0.1 | 18,904 | 7,854 | 22,797 | 20,693 | 7,687 | 5,031 | 5,048 | 6,161 |
| Eta@100 | 1,167 | 761 | 1,610 | 990 | 898 | 2,043 | 2,127 | 2,317 |
| Strain | 28.2 | 12.2 | 20.4 | 42.7 | 11.3 | 2.5 | 2.6 | 2.7 |
| Ratio | | | | | | | | |
| Phase | 33.1 | 24.0 | 28.5 | 34.3 | 34.1 | 36.7 | 36.0 | 35.2 |
| angle | | | | | | | | |
| @628 | | | | | | | | |
| Eta@628 | 391 | 342 | 492 | 345 | 318 | 814 | 832 | 889 |
| Eta0 | 250,948 | 10,931 | 56,916 | 870,406 | — | 5,155 | 5,607 | 6,338 |
| (Pa * s) | | | | | | | | |
| Crossover | 46.5 | 50 | 25.3 | 27.2 | — | 260 | 239 | 217 |
| frequency | | | | | | | | |
| (rad/s) | | | | | | | | |
| Crossover | 0.057 | 0.10 | 0.061 | 0.037 | — | 0.24 | 0.20 | 0.24 |
| modulus | | | | | | | | |
| (MPa) | | | | | | | | |

¹H NMR data of the polymers was collected at 120° C. using a 10 mm cryoprobe on a 600 MHz Bruker spectrometer with 1,1,2,2-tetrachloroethane-d2 (tce-d2). Samples were prepared with a concentration of 30 mg/mL at 140° C. Data was recorded with a 30° pulse, 5 second delay, 512 transients. Signals were integrated and the numbers of unsaturation types per 1000 carbons were reported. The shift regions for unsaturations are shown below in Table 2E.

TABLE 2E

| | ¹H NMR | # | |
|---|---|---|---|
| | Shift | Hydrogen | |
| Identified | Region | per | |
| Species | (ppm) | Structure | Calculation |
| Vinyl | 4.95-5.10 | 2 | (Vinyl/2) * 1000/(total) |
| Vinylidene | 4.70-4.84 | 2 | (Vinylidene/2) * 1000/(total) |
| Vinylene | 5.31-5.55 | 2 | (Vinylene/2) * 1000/(total) |
| Trisubstituted | 5.11-5.30 | 1 | (trisub/1) * 1000/(total) |
| Aliphatic | 0-2.1 | 2 | Aliphatic/2 |
| Total | — | — | Vinyl + vinylidene + |
| | | | vinylene + trisub * |
| | | | 2 + aliphatic/2 |

Table 2F presents the results from the calculations of Table 2E for vinyl/1000TC from 1H NMR analysis of Inventive Examples 1-3 and Comparative Examples 1-4.

TABLE 2F

| Calculated | | | | | | | |
|---|---|---|---|---|---|---|---|
| Results | | | | | | | |
| from ¹H | | | | | | | |
| NMR | CE1 | CE2 | CE3 | CE4 | IE1 | IE2 | IE3 |
| vinyl/ | 0.79 | N/A | N/A | 0.86 | 0.13 | 0.14 | 0.18 |
| 1000 TC | | | | | | | |

### Blown Film Characteristics and Tests

Prior to blown film extrusion, 500 ppm primary AO IRGANOX® 1010, 1000 ppm secondary AO Irgafos 168 and 150 ppm of zinc stearate were blended with some of the comparative and inventive resins and compounded by using a twin-screw extruder. The setting and operations of a twin-screw extruder were known to skilled persons in the art.

No nucleating agents were used except for Inventive Example 4 (IE4), which was prepared by blending IE1 with 2.5 weight % (wt. %) of ULTRAGUARD™ 2.0 (Milliken & Company, Spartanburg, S.C., USA) during film extrusion (“on-line blending”).

Comparative Examples, and 3-4 and Inventive Examples 1 and 3-4 each had an MI2 below 2 and thus could be extruded into films using an industrial scale blown film line. The samples were converted into monolayer films using an Alpine blown film line equipped with 90 mm screw, 160 mm die diameter, 60 mil die gap, zone temperatures were set to between 420 to 435° F., BUR equal to 2.5, frost line height about 22 to 24 inches, output about 10 lbs/hr per inch die. Melt temperature was kept at about 420° F. Films with 1 mil nominal thickness were made. Film tensile properties were obtained per ASTM D882. Film 1% secant modulus properties were obtained per ASTM D882. Film tear properties were obtained per ASTM D1922. Film optical properties were obtained per ASTM D1003. Duplicate monolayer film samples extruded as described above were cut into about 10 cm×about 10 cm for WVTR measurement, the exposed area for testing was 50 square centimeter according to ASTM-F1249. Five (5) thickness measurements were taken, and the average was used for calculation. The testing temperature was fixed at 37.8° C. Other testing procedures were performed according to ASTM F1249. Tables 3A-3B illustrate film physical properties and barrier properties of the inventive examples compared with comparative examples selected for their suitable for forming flexible packaging films.

TABLE 3A

| Tensile Properties | CE1 | CE3 | CE4 | IE1 | IE3 | IE4 |
|---|---|---|---|---|---|---|
| Yield Strength (psi) | | | | | | |
| MD | 4510 | 4910 | 4870 | 3290 | 3160 | 3390 |
| TD | 5040 | 2260 | 4350 | 4050 | 4090 | 4360 |
| Elongation at Yield | | | | | | |
| (%) | | | | | | |
| MD | 4.7 | 4.9 | 2.9 | 4.7 | 4.5 | 4.6 |
| TD | 4.3 | 4.2 | 2.5 | 4.6 | 4.7 | 4.5 |
| Tensile Strength (psi) | | | | | | |
| MD | 8384 | 13500 | 6630 | 8060 | 8300 | 8310 |
| TD | 5036 | 5380 | 4690 | 6920 | 7070 | 5120 |
| Elongation at Break | | | | | | |
| (%) | | | | | | |
| MD | 523 | 470 | 360 | 800 | 800 | 800 |
| TD | 5.3 | 4.2 | 5.1 | 890 | 870 | 690 |
| 1% Secant Modulus | | | | | | |
| (psi) | | | | | | |
| MD | 152424 | 151000 | 151000 | 103000 | 102000 | 108000 |
| TD | 152424 | 210000 | 226000 | 137000 | 131000 | 131000 |
| Elmendorf Tear Force | | | | | | |
| (g) | | | | | | |
| MD | 10.6 | 19.9 | 6.9 | 21.8 | 24.6 | 17.4 |
| TD | 785 | 1198.7 | 585.4 | 178.4 | 182.7 | 147.4 |
| Film Density | | 0.953 | 0.957 | 0.946 | 0.946 | 0.946 |

TABLE 3B

| | CE1 | CE3 | CE4 | IE1 | IE3 | IE4 |
|---|---|---|---|---|---|---|
| Total Haze (%) | 39 | 62 | 55 | 36 | 41.6 | 32.1 |
| Oxygen Transmission Rate | 252 | 396.7 | — | 197.3 | 201.3 | 86.6 |
| (cm³ · mil/100 in² · day) | | | | | | |
| Water Vapor Transmission Rate | 10.1; | 13.0; | 11.7; | 6.8; | 7.0; | 3.3; |
| (g · mil/m² · day); or | 0.651 | 0.838 | 0.755 | 0.439 | 0.452 | 0.213 |
| (g · mil/100 in² · day) | | | | | | |
| Film Density | — | 0.953 | 0.957 | 0.946 | 0.946 | 0.946 |

As stated above, IE4 is made from IE1 with 2.5 wt. % Milliken's ULTRAGUARD™ 2.0 nucleating agent. Although IE1, IE2, and IE3 have relatively lower densities than the comparative examples, all had lower values of water vapor transmission rate (WVTR).

Table 4 summarizes various rigid application properties of Inventive Example 1 compared with Comparative Examples 5 and 6, selected for their suitability for forming rigid molded articles. Rheological properties, thermal properties, and tensile properties were determined as described above. Heat deflection temperature (HDT) was determined by ISO179. Charpy impact strength was determined according to ASTM D256. IZOD impact strength was determined according to ASTM D256.

TABLE 4

| | CE5 | CE6 | IE1 |
|---|---|---|---|
| MI2 (g/10 min) | 1.8 | 6.7 | 1.5 |
| HLMI (g/10 min) | 107 | — | 24.6 |
| HLMI/MI2 | 58 | — | 16.4 |
| Density (g/cc) | 0.953 | 0.952 | 0.954 |
| Peak Tₘ (° C.) | 130 | 132 | 133.5 |
| HDT (° C.) | 43.4 | 44.0 | 43.0 |
| Yield strength (MPa) | 27.2 | 26 | 26.7 |
| Tensile strength (MPa) | 31.3 | — | 38.8 |
| Charpy Impact (23° C.) (KJ/m²) | 3.8 | — | 31 |
| IZOD Impact (23° C.) (Ft-lb/in) | 0.775 | — | 13.3 |
| IZOD Impact (−40° C.) (Ft-lb/in) | 0.683 | 0.92 | 5.8 |
| Flexural Modulus (MPa) | 1270 | 1300 | 1160 |

IE4 is made from IE1 with 2.5 wt. % Milliken Ultraguard 2.0 nucleating agent master batch. Although IE1 and IE3 have relatively lower density than the comparatives, they are actually better moisture barrier films for lower values of Water Vapor Transmission Rate (WVTR). This structure may have unique synergy with the nucleating agent. IE4 has a WVTR of about 3.43 g·mil/m²*day (0.21 g*mil/100 inch²*day).

Although density and crystallinity are the main factors previously used to control moisture barrier properties, the relatively narrow crystal size distributions of the inventive examples appear to provide good barrier properties with relatively low densities (<0.960 g/cm³), especially when used with a nucleating agent. In addition, while optimizing barrier properties by increasing density in general will sacrifice other physical properties such as impact strength, the inventive examples exhibit impact strength a few times higher than that of injection molding grade HDPEs (Comparative Examples 5 and 6), making the inventive examples suitable for both flexible and rigid applications.

All documents described herein are incorporated by reference herein for purposes of all jurisdictions where such practice is allowed, including any priority documents and/or testing procedures to the extent that they are not inconsistent with this text. As is apparent from the foregoing general description and the specific embodiments, while forms of the disclosure have been illustrated and described, various modifications may be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein.

What is claimed is:

1. A polyethylene comprising:
(a) a resin density of about 0.950 grams/cubic centimeter (g/cm³) to about 0.960 g/cm³, as measured in accordance with ASTM D1505;
(b) a melt index at 2.16 kg loading and 190° C. of about 0.5 grams/10 minutes (g/10 min) to about 2 g/10 min, as measured in accordance with ASTM D1238;
(c) a high load melt index at 21.6 kg loading and 190° C. of about 15 g/10 min to about 28 g/10 min, as measured in accordance with ASTM D1238;
(d) a polydispersity index of about 3 or less, as measured by gel permeation chromatography; and
(e) a crystallization peak width at half height of about 5° C. or less, as measured in accordance with ASTM D3418.

2. The polyethylene of claim 1, wherein the polyethylene is a polyethylene homopolymer.

3. The polyethylene of claim 1, further comprising:
a melt index at 2.16 kg loading and 190° C. of about 1.2 grams/10 minutes (g/10 min) to about 2 g/10 min, as measured in accordance with ASTM D1238.

4. The polyethylene of claim 1, further comprising:
a melt index ratio of about 12 to about 17, as measured in accordance with ASTM D1238.

5. The polyethylene of claim 1, further comprising:
a polydispersity index of about 2 to about 3, as measured by gel permeation chromatography.

6. The polyethylene of claim 1, further comprising:
a crystallization peak width at half height of about 3° C. to about 5° C. as measured by DSC in accordance with ASTM D3418.

7. The polyethylene of claim 1, further comprising:
a crystallization maximum peak height×100 to a crystallization enthalpy ratio having an absolute value of about 2.5 to about 2.8 W/J, as measured by differential scanning calorimetry in accordance with ASTM D3418.

8. The polyethylene of claim 1, further comprising:
a ratio of z-average molecular weight to weight-average molecular weight of about 2 or less, as measured by gel permeation chromatography.

9. The polyethylene of claim 1, further comprising:
a ratio of z-average molecular weight to weight-average molecular weight of about 1.5 to about 2, as measured by gel permeation chromatography.

10. The polyethylene of claim 1, further comprising:
a vinyl carbon to 1000 total carbon ratio of about 0.1 to about 0.2, as measured by proton nuclear magnetic resonance (¹H NMR) spectroscopy.

11. The polyethylene of claim 1, further comprising:
a single peak melting temperature of about 133° C. to about 134° C., as measured by differential scanning calorimetry in accordance with ASTM D3418.

12. The polyethylene of claim 1, further comprising:
an Eta0 of about 4000 Pa·s to about 7000 Pa·s, according to the Carreau-Yasuda model of complex viscosity values, as measured at 190° C. using a parallel plate rheometer at 0.01 rad/s to 698 rad/s angular frequency; and/or
a strain ratio of about 10 or less, as measured at 190° C. using a parallel plate rheometer at 0.01 rad/s and 100 rad/s angular frequency.

13. The polyethylene of claim 1, further comprising:
an IZOD impact strength at −40° C. of about 3 or greater foot-pounds per inch (ft-1b/in), as measured in accordance with ASTM D256; and/or
an IZOD impact at −40° C. of about 5 or greater foot-pounds per inch (ft-lb/in), as measured in accordance with ASTM D256, and a Charpy impact strength at 23° C. of about 25 or greater kilojoules per square meter (KJ/m²), as measured in accordance with ISO 179.

14. A polyethylene film comprising a polyethylene of claim 1, further comprising a film density greater than 0.944 grams/cubic centimeter (g/cm³).

15. The polyethylene film of claim 14, further comprising a film density less than 0.953 grams/cubic centimeter (g/cm³).

16. The polyethylene film of claim 14, wherein the polyethylene film lacks a nucleating agent, and the polyethylene film has a water vapor transmission rate of about 7 or less grams per mil per square meter per day (g·mil/m²·day), as measured in accordance with ASTM-F1249.

17. The polyethylene film of claim 14, wherein the polyethylene film further comprises a nucleating agent, and the polyethylene film has a water vapor transmission rate of 4 or less g·mil/m²·day.

18. The polyethylene film of claim 14, wherein the polyethylene film lacks a nucleating agent, and the polyethylene film has an oxygen transmission rate of about 190 cubic centimeters per mil per 100 square inches per day (cm³·mil/100 in²·day) to about 210 cm³·mil/100 in²·day, as measured in accordance with ASTM D3985.

19. The polyethylene film of claim 14, wherein the polyethylene film further comprises a nucleating agent, and the polyethylene film has an oxygen transmission rate of about 80 to 90 cubic centimeters per mil per 100 square inches per day (cm³·mil/100 in²·day), as measured in accordance with ASTM D3985.

20. The polyethylene film of claim 14, wherein the polyethylene film exhibits:
an elongation at break in the machine direction of about 600% or greater, as measured in accordance with ASTM D882; and/or
an elongation at break in the transverse direction of about 600% or greater, as measured in accordance with ASTM D882.

21. The polyethylene film of claim 14, wherein the polyethylene film exhibits:
a 1% secant modulus in the machine direction of about 100 or greater kilopounds per square inch (kpsi); and/or
a 1% secant modulus in the transverse direction of about 130 or greater kpsi, as measured in accordance with ASTM D882.

22. A method comprising:
combining ethylene with a catalyst system in a slurry loop reactor, the catalyst system comprising:
(i) bis(n-propylcyclopentadienyl) zirconium dichloride;
(ii) a support material; and
(iii) an activator; and
obtaining the polyethylene of claim 1.

23. The method of claim 22, wherein the slurry loop reactor is a single slurry loop reactor.
